(19) United States
(12) Patent Application Publication
(10) Pub. No.: US 2026/0158487 A1
(43) Pub. Date: Jun. 11, 2026

(54) DETECTION KIT AND TARGET MOLECULE DETECTION METHOD

(71) Applicant: TOPPAN HOLDINGS INC., Tokyo (JP)

(72) Inventors: Yosuke HORIUCHI, Taito-ku (JP); Ryosuke YOKOTA, Taito-ku (JP)

(73) Assignee: TOPPAN HOLDINGS INC., Tokyo (JP)

(21) Appl. No.: 19/181,854

(22) Filed: Apr. 17, 2025

Related U.S. Application Data
(63) Continuation of application No. PCT/JP2023/037861, filed on Oct. 19, 2023.

(30) Foreign Application Priority Data
Oct. 20, 2022 (JP) 2022-168341
Oct. 20, 2022 (JP) 2022-168342

(51) Int. Cl. B01L 3/00; G01N 21/64

(52) U.S. Cl. CPC B01L 3/502; G01N 21/6428; B01L 2200/0647; B01L 2200/0689; B01L 2200/16; B01L 2300/0829; B01L 2400/0409; B01L 2400/0457; G01N 2021/6439

(57) ABSTRACT

A detection kit includes a detection device for a target molecule; and sealing liquid for the detection device, the sealing liquid being a mixed solution of lipophilic liquid and a surfactant, the surfactant in the sealing liquid having a concentration of 1 vol % or more and 100 vol % or less relative to a saturation concentration of the surfactant in the sealing liquid. The detection device includes a first well plate including first wells on one surface, and a second well plate including second wells on one surface, the first well plate and the second well plate are disposed with the first wells and the second wells opposed to each other, a flow channel in which a fluid flows is formed between the first well plate and the second well plate, and the first wells overlap with the second wells in plan view.

### CROSS-REFERENCE TO RELATED APPLICATIONS

The present application is a continuation of and claims the benefit of priority to International Application No. PCT/JP2023/037861, filed Oct. 19, 2023, which is based upon and claims the benefit of priority to Japanese Applications No. 2022-168341, filed Oct. 20, 2022 and No. 2022-168342, filed Oct. 20, 2022. The entire contents of these applications are incorporated herein by reference.

### BACKGROUND OF THE INVENTION

### Field of the Invention

The present invention relates to a detection kit and a target molecule detection method.

### Description of Background Art

For example, JP 5551798 B, JP 2014-503831 A, and Kim S. H., et al., Large-scale femtoliter droplet array for digital counting of single biomolecules., Lab on a Chip, 12 (23 ), 4986-4991, 2012 describe technology of producing enzyme reactions in a large number of micro compartments for monomolecular detection as a technique of accurately detecting target molecules. The entire contents of these publications are incorporated herein by reference.

### SUMMARY OF THE INVENTION

According to one aspect of the present invention, a detection kit includes a detection device for a target molecule, and a sealing liquid for the detection device. The sealing liquid is a mixed solution including a lipophilic liquid and a surfactant such that the surfactant has a concentration in a range of 1 vol % to 100 vol % relative to a saturation concentration of the surfactant in the sealing liquid, and the detection device includes a first well plate including first wells on one surface, and a second well plate including second wells on one surface such that the first well plate and the second well plate are configured to position the first wells and the second wells opposed to and overlapping with each other and form a flow channel between the first well plate and the second well plate.

According to another aspect of the present invention, a detection kit includes a detection device for a target molecule, and a sealing liquid for the detection device. The sealing liquid is a mixed solution of a lipophilic liquid and a surfactant such that the surfactant has a concentration in a range of 1 vol % to 100 vol % relative to a saturation concentration of the surfactant in the sealing liquid, and the detection device includes a substrate, a wall member that is positioned on the substrate, and a cover member that is positioned on the wall member such that the cover member is opposed to the substrate and in contact with the wall member and has an inlet and an outlet extending through the cover member in a thickness direction thereof, the cover member forms a flow channel extending between a top of the wall member and the cover member, and the detection device has first wells surrounded by the substrate and the wall member.

According to yet another aspect of the present invention, a target molecule detection method includes providing a detection device including a first well plate including first wells on one surface and a second well plate including second wells on one surface such that the first wells and the second wells are opposed to each other, filling each of the first wells with a sample solution including a target substance such that the sample solution is isolated and sealed in the first well by sealing liquid, obtaining a particulate evaluation target including the target molecule from the target substance in a first well in which the one target substance is disposed, filling each of the second wells with a buffer, bringing a surface of the first well plate on which the first wells are formed and a surface of the second well plate on which the second wells are formed into contact, distributing the evaluation targets to the second wells isolated from each other one by one from the first wells, and producing a reaction between the evaluation target and a detection reagent such that the target molecule in the evaluation target is detected. The surface on which the first wells are formed and the surface on which the second wells are formed are in contact for a time longer than a contact time expressed by T=d1/v in the distributing where T is a contact time in sec, d1 is a diameter of the evaluation target in μm, and v is migration speed in μm/sec at which the evaluation target migrates from the first well to the second well in the sample solution.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram illustrating a detection kit 500 according to a first embodiment;

FIG. 2 is a cross-sectional view taken along a line II-II of FIG. 1;

FIG. 3 is a cross-sectional view of an alternative embodiment of a detection device 100;

FIG. 4 is an explanatory diagram of a target molecule detection method according to the first embodiment;

FIG. 5 is an explanatory diagram of the target molecule detection method according to the first embodiment;

FIG. 6 is an explanatory diagram of the target molecule detection method according to the first embodiment;

FIG. 7 is an explanatory diagram of the target molecule detection method according to the first embodiment;

FIG. 8 is an explanatory diagram of the target molecule detection method according to the first embodiment;

FIG. 9 is an explanatory diagram of the target molecule detection method according to the first embodiment;

FIG. 10 is an explanatory diagram of the target molecule detection method according to the first embodiment;

FIG. 11 is a cross-sectional view of a detection device 200 according to the present embodiment taken along arrows;

FIG. 12 is an explanatory diagram of a target molecule detection method according to a second embodiment;

FIG. 13 is an explanatory diagram of the target molecule detection method according to the second embodiment;

FIG. 14 is an explanatory diagram of the target molecule detection method according to the second embodiment;

FIG. 15 is a schematic perspective view of a fluid device 300 included in a detection kit according to a third embodiment;

FIG. 16 is a cross-sectional view taken along a line XV-XV of FIG. 15;

FIG. 17 is an explanatory diagram of a target molecule detection method according to the third embodiment;

FIG. 18 is an explanatory diagram of the target molecule detection method according to the third embodiment;

FIG. 19 is a schematic cross-sectional view of a detection device 400 included in a detection kit according to a fourth embodiment;

FIG. 20 is an explanatory diagram of a target molecule detection method according to the fourth embodiment;

FIG. 21 is an explanatory diagram of the target molecule detection method according to the fourth embodiment;

FIG. 22 is an enlarged photograph illustrating a result according to an Example;

FIG. 23 is an enlarged photograph illustrating a result according to an Example;

FIG. 24 is an enlarged photograph illustrating a result according to an Example;

FIG. 25 is an enlarged photograph illustrating a result according to a comparative example;

FIG. 26 is an enlarged photograph illustrating a result according to a comparative example;

FIG. 27 is an enlarged photograph illustrating a result according to a comparative example;

FIG. 28 is an enlarged photograph illustrating a result according to an experimental example;

FIG. 29 is an enlarged photograph illustrating a result according to an experimental example;

FIG. 30 is an enlarged photograph illustrating a result according to an experimental example;

FIG. 31 is an enlarged photograph illustrating a result according to an experimental example; and

FIG. 32 is an enlarged photograph illustrating a result according to an experimental example.

### DETAILED DESCRIPTION OF THE EMBODIMENTS

Embodiments will now be described with reference to the accompanying drawings, wherein like reference numerals designate corresponding or identical elements throughout the various drawings.

### First Embodiment

Hereinafter, a first embodiment will be described in detail with reference to the drawings where necessary.

### Detection Kit

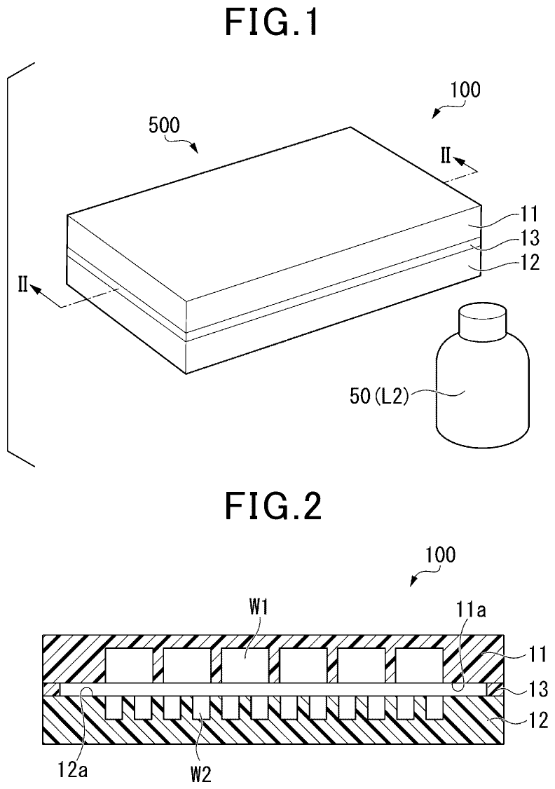

FIG. 1 is a schematic diagram illustrating a detection kit 500 according to the present embodiment. The detection kit 500 includes a detection device 100 and oil-based sealing liquid L2. The sealing liquid L2 is stored, for example, in a storage container 50. The detection kit 500 is used to detect target molecules included in a liquid sample. The detection kit 500 may include a detection reagent for detecting target molecules.

### Detection Device

FIG. 2 is a cross-sectional view of the detection device 100 taken along a line II-II of FIG. 1.

The detection device 100 includes a first well plate 11, a second well plate 12, and a wall member 13. The detection device 100 is used as a reaction container that stores a sample therein, causes target substances included in the sample to release target molecules, and is for performing detection reactions of the target molecules. In that case, the target substances included in the sample are caused to release the target molecules in the first well plate 11 and the target molecules moving from the first well plate are detected in the second well plate 12.

The first well plate 11 and the second well plate 12 are detachably stacked with the wall member 13 in between.

### First Well Plate and Second Well Plate

The first well plate 11 is a plate-shaped member having a rectangular shape in plan view. The “plan view” refers to a view from the normal direction of the upper surface of the first well plate 11. In the following description, the first well plate 11 will be sometimes abbreviated as the “first plate 11”. Similarly, the second well plate 12 will be sometimes abbreviated as the “second plate 12”.

The first plate 11 includes first wells W1 on a well forming surface 11a that faces the inner surface of the detection device 100. Each of the first wells W1 is a recess provided on the well forming surface 11a of the first plate 11 and opens on the well forming surface 11a.

The second plate 12 is a plate-shaped member having a rectangular shape in plan view and has the same outline shape as the outline shape of the first plate 11 in plan view. The first plate 11 and the second plate 12 have the first wells W1 and second wells W2 opposed to each other and are spaced apart from each other.

The second plate 12 includes the second wells W2 on a well forming surface 12a that faces the inner surface of the detection device 100. Each of the second wells W2 is a recess provided on the well forming surface 12a of the second plate 12 and opens on the well forming surface 12a.

Materials of the first plate 11 and the second well plate may each have electromagnetic wave transmission properties or do not each have to have any electromagnetic wave transmission properties. Here, electromagnetic waves whose transmission properties are determined include X rays, ultraviolet rays, visible light rays, infrared rays, and the like. In a case where the first plate 11 and the second well plate each have electromagnetic wave transmission properties, it is possible to use electromagnetic waves to analyze a result of an experiment conducted in the detection device 100. For example, it is possible to measure fluorescence, phosphorescence, or the like resulting from the irradiation of electromagnetic waves through the first plate 11 or the second well plate. The “electromagnetic wave transmission properties” mean properties of it being possible to transmit electromagnetic waves having various wavelengths such as radio waves, light, X rays, and gamma rays.

Examples of the materials each having electromagnetic wave transmission properties include glass, resin, and the like. Examples of the resin include ABS resin, polycarbonate, COCs (cycloolefin copolymers), COPs (cycloolefin polymers), acrylic resin, polyvinyl chloride, polystyrene, polyethylene, polypropylene, polyvinyl acetate, PET (polyethylene terephthalate), PEN (polyethylene naphthalate), PC (polycarbonate), silicone resin, fluororesin, amorphous fluororesin, and the like. These resins may include various additives or may be polymer alloys in which resins are mixed.

It is preferable that the materials having electromagnetic wave transmission properties each have substantially no autofluorescence. Having substantially no autofluorescence means that a material does not have any autofluorescence at any wavelength used to detect a sample, or alternatively, the autofluorescence is so weak that the detection of a sample is not influenced. For example, autofluorescence that is about ½ or less or 1/10 or less of fluorescence to be detected can be regarded as so weak autofluorescence that the detection of a sample is not influenced. When the first plate 11 and the second well plate are each formed by using such a material, it is possible to increase the sensitivity of the detection of a sample in which electromagnetic waves are used.

An example of the material that has electromagnetic wave transmission properties and emits no autofluorescence includes quartz glass. Materials that have weak autofluorescence and do not affect the detection of a sample in which electromagnetic waves are used include low-fluorescence glass, acrylic resin, COCs (cycloolefin copolymers), COPs (cycloolefin polymers), and the like.

It is preferable that the material of the first plate 11 be softer than the material of the second plate 12 (i.e., have a lower elastic modulus than the elastic modulus of the material of the second plate 12). Of the materials described above, for example, silicone resin is preferable as the material of the first plate 11. It is possible to favorably use, for example, PDMS (polydimethylsiloxane) as the silicone resin. Both of the materials of the first plate 11 and the second plate 12 may be PDMS.

The first plate 11 and the second plate 12 may each have a monolayer structure in which any of the materials alone is used or may be a laminate of materials. In the case of processing the laminate to form the first plate 11 and the second well plate, layers including wells (the first wells W1 or the second wells W2) and layers that support the layers including the wells may include different materials. For example, a laminate in which fluororesin is on a substrate may be used as the material of the first plate 11 and the fluororesin layer may be processed to form a well array. The same applies to the second plate 12. It is possible to use, for example, CYTOP (registered trademark) (AGC Inc.) or the like as the fluororesin.

It is possible to determine the thickness of the second plate 12 as appropriate. In a case where fluorescence is observed from the second plate 12 side by using a fluorescence microscope, the second plate 12 may have, for example, a thickness of 5 mm or less, 2 mm or less, or 1.6 mm or less. It is possible to determine the thickness of the first plate 11 as appropriate as long as the effects of an embodiment of the invention are not impaired.

### First Well and Second Well

The first wells W1 are each used as a field that stores a sample stored inside the detection device 100 and causes a target substance included in the sample to release a target molecule.

In addition, the second wells W2 each store the target molecule released in the first well W1 and functions as a reaction field of the target substance and a detection reagent for the target substance.

### Shape of Well

It is possible to adopt various shapes as the shapes of the first well W1 and the second well W2. Examples thereof include a tubular shape such as a cylinder, an oval cylinder, and a polygonal tube, a conic shape such as a cone and a pyramid, and a frustum shape such as a truncated cone and a truncated pyramid. In a case where the first well W1 and the second well W2 each have a conic shape or a frustum shape, it is favorable that the shape have an opening diameter that gradually decreases in the depth direction of the well.

The bottoms of the first well W1 and the second well W2 may be flat or curved (having a protruding surface or a recessed surface).

In a case where the first wells W1 each have a circular shape in plan view, the opening section of the first well W1 may have, for example, a diameter (also referred to as an opening diameter) of about 10 to 500 μm. In a case where the second wells W2 each have a circular shape in plan view, the opening section of the second well W2 may have, for example, a diameter (also referred to as an opening diameter) of about 1 to 100 μm. It is preferable that the opening diameter of the first well W1 be greater than the opening diameter of the second well W2.

The first well W1 may have, for example, a depth of about 5 μm to 500 μm. The “depth of the first well W1” refers to the distance from a “virtual plane parallel with the well forming surface 11a and in contact with the well forming surface 11a” to the “deepest section of the first well W1”.

In addition, the second well W2 may have, for example, a depth of about 1 μm to 100 μm. The “depth of the second well W2” refers to the distance from a “virtual plane parallel with the well forming surface 12a and in contact with the well forming surface 12a” to the “deepest section of the second well W2”.

### Number of Wells

The detection device 100 includes 10 to 10000 first wells W1. In addition, in the detection device 100, the first wells W1 are disposed to overlap with the second wells W2 in plan view. In this case, the first wells W1 may be configured to overlap with the second wells W2 in plan view at 1:1 or the first wells W1 may be each configured to overlap with the two or more second wells W2 in plan view.

The number of second wells W2 overlapping with one first well W1 in plan view is 1 to 10000. It is preferable that the number of second wells W2 overlapping with one first well W1 in plan view be 10 to 10000. That is, a number of second wells W2 satisfying the number described above are preferably formed on the second plate 12.

It may be possible to manufacture the first plate 11 and the second plate 12 described above by using publicly known injection molding, microprinting technology, or nanoimprinting technology. In addition, it may also be possible to manufacture the first plate 11 and the second plate 12 by forming wells by etching with publicly known photolithographic technology.

### Wall Member

The wall member 13 is formed to have a closed annular shape in plan view and sandwiched between the first plate 11 and the second plate 12. The wall member 13 functions as a spacer that separates the first plate 11 and the second plate 12 and produces a space between the first plate 11 and the second plate 12.

It is possible to adopt, as a material of the wall member 13, any of the same materials as the materials of the first plate 11 and the second plate 12 described above. It is possible to integrate the wall member 13 formed by using such a material with the first plate 11 or the second plate 12 by bonding the wall member 13 with an adhesive or welding the wall member 13 by thermal welding, ultrasonic welding, laser welding, and the like.

In addition, the material of the wall member 13 may be different from the materials of the first plate 11 and the second plate 12. The wall member 13 may be, for example, a double-sided tape or an adhesive. The base member of the double-sided tape may be plastic or a paper member. The adhesive may be grease or a rapid-curing adhesive having a component such as α-cyanoacrylate.

The wall member 13 may be formed at the same time when any one of the first plate 11 and the second plate 12 is manufactured (i.e., integrally) and may be integrated with the first plate 11 or the second plate 12.

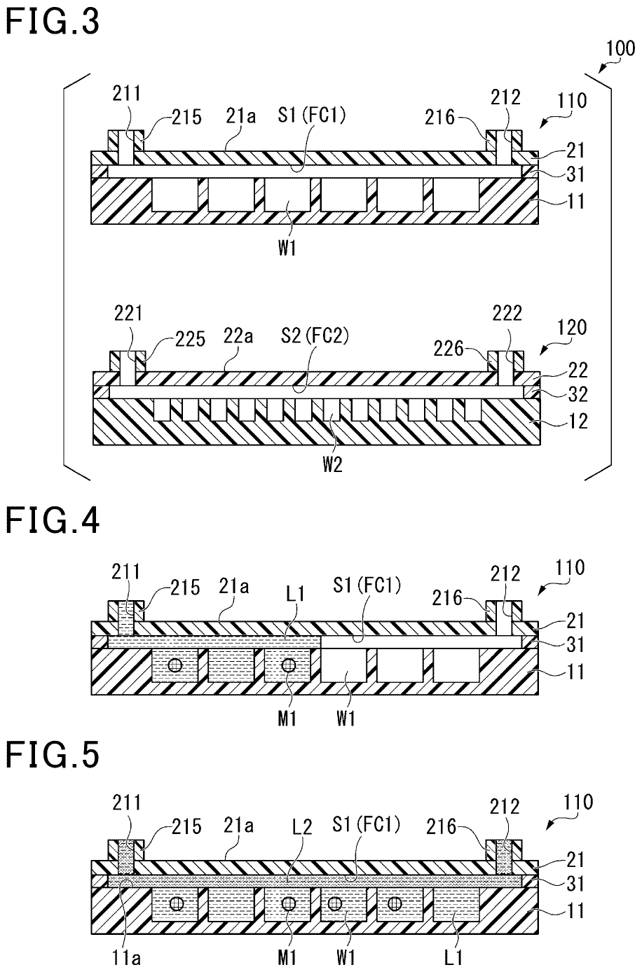

At the time of use, the detection device 100 is used by being separated into the first plate 11 and the second plate 12. FIG. 3 is a cross-sectional view of an alternation of the detection device 100.

A first member 110 includes the first plate 11, a first cover member 21 that is attachable and detachable to and from the first plate 11, and a first wall member 31 sandwiched between the first plate 11 and the first cover member 21.

The first cover member 21 has the same outline shape as the outline shape of the first plate 11 in plan view.

The first cover member 21 has two through holes extending through the first cover member 21 in the thickness direction. The two respective through holes are provided at one of the ends of the first cover member 21 and the other end. One of the through holes is an inlet 211 used when a liquid material is injected into an internal space S1 of the first member 110 and the other through hole is an outlet 212 used when the liquid material is discharged from the internal space S1.

Here, the “liquid material” includes a detection reagent and sealing liquid in addition to a liquid sample.

The inlet 211, the internal space S1, and the outlet 212 are connected in this order to form a flow channel FC1 as a whole. In the first member 110, a liquid material flows to the flow channel FC1 as appropriate and target substances are sealed in the first wells W1. In plan view, the first wells W1 is disposed between the inlet 211 and the outlet 212.

An upper surface 21a of the first cover member 21 is provided with a cylindrical injection port 215 that surrounds the inlet 211. The injection port 215 communicates with the inlet 211. For example, when the internal space is filled with a liquid material using a syringe filled with the liquid material, the injection port 215 is used to connect the syringe.

Similarly, the upper surface 21a of the first cover member 21 is provided with a tubular discharge port 216 that surrounds the outlet 212. The discharge port 216 communicates with the outlet 212. For example, when the liquid material is pulled out from the internal space S1, the discharge port 216 is used to connect a tube to which the liquid material flows.

In addition, a second member 120 includes the second plate 12, a second cover member 22 that is attachable and detachable to and from the second plate 12, and a second wall member 32 sandwiched between the second plate 12 and the second cover member 22.

The second cover member 22 has the same outline shape as the outline shape of the second plate 12 in plan view.

The second cover member 22 has an inlet 221 and an outlet 222 extending through the second cover member 22 in the thickness direction. The inlet 221, the internal space S2 of the second member 120, and the outlet 222 are in communication with each other in this order, and together form a flow path FC2. In the second member 120, a liquid buffer flows to the flow channel FC2 and is sealed in the second wells W2. In plan view, the second wells W2 is disposed between the inlet 221 and the outlet 222.

An upper surface 22a of the second cover member 22 is provided with a tubular injection port 225 that surrounds the inlet 221 and communicates with the inlet 221. In addition, the upper surface 22a is provided with a tubular discharge port 226 that surrounds the outlet 212 and communicates with the outlet 212.

It is possible to adopt, as materials of the first cover member 21 and the second cover member 22, the materials exemplified as the materials of the first plate 11 and the second plate 12 described above. It may be possible to manufacture the first cover member 21 and the second cover member 22 by publicly known injection molding.

### Sealing Liquid

The sealing liquid L2 is a mixed solution of lipophilic liquid and a surfactant. It is possible to use fluorine-based oil, silicone-based oil, hydrocarbon-based oil, a mixture thereof, or the like as the lipophilic liquid (i.e., oil).

More specifically, it is possible to use “FC-40” (product name) (CAS Number: 86508-42-1) manufactured by Sigma-Aldrich Co. LLC or the like as the lipophilic liquid. FC-40 is a fluorinated aliphatic compound (fluorine-based oil) and has a specific gravity of 1.85 g/mL at 25° C.

It is also possible to use both an ionic surfactant and a non-ionic (nonionic) surfactant as the surfactant. In addition, the surfactant is preferably one generally used in biochemical experiments. In a case where cells are target substances, the surfactant is preferably one that does not damage the cell membranes or is less likely to damage the cell membranes. Additionally, in a case where cells are target substances, the concentration of the surfactant in the sealing liquid is preferably adjusted to be a concentration that does not modify or disrupt the cells.

The ionic surfactant includes an anionic surfactant and an amphoteric surfactant.

Examples of the anionic surfactant include sodium dodecyl sulfate, sodium cholate, sodium deoxycholate, and the like.

Examples of the amphoteric surfactant include CHAPS and CHAPSO.

CHAPS: 3-[(3-cholamidopropyl)dimethylammonio]propanesulfonate; and

CHAPSO: 3-[(3-cholamidopropyl)dimethylammonio]-2-hydroxypropanesulfonate.

Examples of the non-ionic surfactant include the following compounds:
Triton X-100 (polyethylene glycol-tert-octylphenyl ether (n =about 10));
Triton X-114 (polyethylene glycol-tert-octylphenyl ether);
Nonidet P-40 (octylphenoxy poly(ethyleneoxy)ethanol);
Tween 20 (polyoxyethylene sorbitan monolaurate);
Tween 40 (polyoxyethylene sorbitan monopalmitate);
Tween 60 (polyoxyethylene sorbitan monostearate);
Tween 80 (polyoxyethylene sorbitan monooleate);
Tween 85 (polyoxyethylene sorbitan trioleate);
Brij-35 (polyoxyethylene(23) lauryl ether);
Brij-58 (polyoxyethylene(20) cetyl ether);
n-octyl-β-D-glucoside;
Octyl glucoside;
Octyl thioglucoside;
Surflon S-386 (fluorine-based surfactant manufactured by AGC Seimi Chemical Co., Ltd.); and
008-FluoroSurfactant (fluorine-based surfactant manufactured by RAN Biotechnologies, Inc.).

The number of repetitions of a polyethylene glycol moiety is 9 or 10 in Triton X-and the number of repetitions of a polyethylene glycol moiety is 7 or 8 in Triton X-114.

The surfactant in the sealing liquid L2 preferably has a concentration of 1 vol% or more and 100 vol% or less relative to the saturation concentration of the surfactant in the sealing liquid, and more preferably 10 vol% or more and 90 vol% or less. Further, the appropriate concentration of the surfactant varies depending on the type of lipophilic liquid used for the sealing liquid L2. Preliminary experiments may preferably be conducted as appropriate to adjust the concentration of the surfactant.

The sealing liquid L2 may be diluted and used for a detection method described below. Therefore, the detection kit 500 may be further equipped with a lipophilic solution alone that includes no surfactant and the lipophilic solution may be used to dilute the sealing liquid L2.

### Target Molecule Detection Method

Each of FIGS. 4 to 9 is an explanatory diagram of a target molecule detection method according to the present embodiment. The target molecule detection method includes the following processes of performing operations. In the target molecule detection method, the detection device 100 is used to detect target molecules included in a sample in the second wells W2 of the detection device 100.
(A1) a process of obtaining a sample solution by adjusting the concentration of a liquid sample including target substances;
(A2) a process of isolating and sealing the sample solution in first wells by sealing liquid;
(A3) a process of causing the target substances to release target molecules in the first wells;
(A4) a process of distributing the target molecules to respective second wells one by one; and
(A5) a process of detecting the target molecules.

### (A1) Obtaining Sample Solution

First, a sample solution L1 is obtained by adjusting the concentration of a liquid sample including target substances. Hereinafter, this process will be sometimes abbreviated as “process (A1)”. In the following description, the respective processes will be sometimes abbreviated similarly.

The sample includes, for example, a biological sample or an environmental sample. The biological sample is not limited in particular and includes serum, plasma, urine, a cell culture solution, and the like. In addition, examples of the environmental sample include river water, factory wastewater, and the like.

The biological sample and the environmental sample each include target substances that release target molecules to be detected. Examples of the target substances include DNA, RNA, protein, viruses, cells, specific compounds, and the like. The RNA includes miRNA, mRNA, and the like. In addition, the cells include bacteria, yeast, animal cells, plant cells, insect cells, and the like.

The sample may include a reaction reagent for detecting target substances. The reaction reagent includes buffer substances, enzymes, substrates, antibodies, antibody fragments, and the like. For example, in a case where target substances are nucleic acids, the enzymes are selected depending on the contents of a biochemical reaction such as an enzyme reaction on template nucleic acids related to the target substances to produce the biochemical reaction. The biochemical reaction on template nucleic acids is, for example, a reaction in which signal amplification occurs under the condition that template nucleic acids are present.

In addition, in a case where a protein is detected, an enzyme may be bound to an antibody to detect the protein in an enzyme reaction. HRP, alkaline phosphatase, β-galactosidase, or the like may be used as the detection enzyme.

The reaction reagent is selected depending on a detection reaction to be adopted. A specific detection reaction includes an invasive cleavage assay (ICA) method, a loop-mediated isothermal amplification (LAMP) method (registered trademark), a 5′ to 3′ nuclease method (TaqMan (registered trademark) method), a fluorescence probe method, and the like.

The sample may include a surfactant. Examples of the surfactant include Triton-X100 (also referred to as polyethylene glycol mono-4-octylphenyl ether (n=about 10)), sodium dodecyl sulfate, Nonidet P-40 (also referred to as octylphenoxy poly(ethyleneoxy)ethanol), Tween 20 (also referred to as polyoxyethylene sorbitan monolaurate), and the like.

The concentration of the sample is adjusted to a concentration at which one target substance M1 is disposed in each of the first wells W1 on the basis of the capacity of the detection device 100 to be used. The concentration of the sample is preferably determined by conducting a preliminary experiment with the detection device 100.

### (A2) Isolating and Sealing Sample Solution

Subsequently, the first wells W1 is each filled with the sample solution L1 independently. Hereinafter, this process will be sometimes abbreviated as “process (A2)”. The detection device 100 is divided into the first member 110 and the second member 120 and the first member 110 is then used in this process.

First, as illustrated in FIG. 4, the sample solution L1 including a detection reagent is injected into the internal space S1 from the inlet 211. When the sample solution L1 flows in the internal space S1 (also referred to as the flow channel FC1), the first wells W1 open in the internal space S1 are each filled with the sample solution L1.

After the internal space S1 and all the first wells W1 are filled with the sample solution L1, the sample solution L1 passing through the flow channel FC1 is discharged from the outlet 212.

In this case, the concentration of the sample solution L1 is adjusted in advance to fill one first well W1 with one target substance M1. Specifically, in a case where the capacity (in other words, the volume of the sample solution L1 injected into the internal space S1) of the internal space S1 and the total number of first wells W1 are known, the concentration of the sample solution L1 is adjusted such that the number of target substances M1 to be injected into the internal space S1 is, for example, less than or equal to a 1/10 of the total number of first wells W1. This operation fills the one first well W1 with one or less target substances M1, that is, zero or one target substance M1.

The measure for introducing the target substances M1 to the first wells W1 is not limited in particular and it is possible to select appropriate measure for the target substances M1 to be detected. For example, the target substances M1 may be distributed to the first wells W1 by their own weight or may be introduced to the first wells W1 by being distributed by diffusion.

In addition, substances (also referred to as capture substances) that capture the target substances M1 may be used and the capture substances may be bound to the target substances M1 that do not easily fall by its own weight to send the target substances M1. Furthermore, it is also possible to increase the efficiency of introducing the target substances M1 to the first wells W1 by fixing the capture substances to the first wells W1 in advance and causing the capture substances to capture the target substances M1 supplied with the sample solution.

Alternatively, the target substances M1 may be introduced to the first wells W1 after the capture substances are introduced to the first wells W1, and the capture substances and the target substances M1 may be brought into contact in the first wells W1.

The capture substances are substances each capable of capturing the target substance M1. The capture substance may be, for example, a conjugate of a solid phase and a specific binding substance for the target substance M1.

The specific binding substance includes an antibody, an antibody fragment, an aptamer, and the like. The antibody fragment includes Fab, F(ab′)2, Fab′, a single-chain antibody (scFv), a disulfide stabilized antibody (dsFv), a dimeric V region fragment (diabody), a peptide including a CDR, and the like. The antibody may be a monoclonal antibody or a polyclonal antibody. In addition, the antibody may be a commercially available antibody.

In addition, in a case where the target substances M1 each include a sugar chain, the specific binding substance may be lectin. In addition, in a case where the target substances M1 each include a lipid membrane, the specific binding substance may be a lipid membrane binding substance. Examples of the lipid membrane binding substance include hydrocarbon such as hexanediol and membrane protein such as transmembrane protein. Examples of the membrane protein include α-hemolysin and the like.

The solid phase included in the capture substance includes a particle, a membrane, a substrate, and the like. In addition, the specific binding substance for the target substance M1 may come in one type or two or more types. For example, the specific binding substance may come in three types, four types, or five or more types.

The particle is not limited in particular and includes a polymer particle, a magnetic particle, a glass particle, and the like. As the particle, a particle subjected to surface treatment to avoid nonspecific adsorption is preferable. In addition, to fix the specific binding substance, a particle including a functional group such as a carboxyl group on the surface is preferable. More specifically, it is possible to use “Magnosphere LC300” (product name) manufactured by JSR Corporation, or the like.

A method for fixing the specific binding substance to the solid phase is not limited in particular and includes a method in which physical adsorption is used, a method in which chemical bonding is used, a method in which avidin-biotin binding is used, a method in which the binding of protein G or protein A to an antibody is used, and the like.

The method in which physical adsorption is used may include a method for fixing the specific binding substance to a particle surface with hydrophobic interaction or electrostatic interaction.

The method in which chemical bonding is used may include a method in which a crosslinking agent is used. For example, in a case where the surface of a particle includes a hydroxyl group, it is possible to fix the specific binding substance to the particle surface by reacting a carboxyl group of the specific binding substance with a cross-linking agent to obtain an active ester and then reacting the hydroxyl group with this ester group.

To avoid impairing the ability of the specific binding substance to recognize the target substance M1, a spacer is preferably provided between the specific binding substance and the particle surface.

In addition, for example, in a case where viruses are used as the target substances M1, cells to which the viruses are attachable (i.e., cells each having a virus receptor) may be used as capture substances.

Subsequently, as illustrated in FIG. 5, the sealing liquid L2 is injected into the internal space S1 from the inlet 211. The sealing liquid L2 may be the undiluted sealing liquid L2 in the storage container 50 or a dilution of the sealing liquid L2.

The sealing liquid L2 flows in the internal space S1 in the planar direction of the well forming surface 11a. Of the sample solution L1 supplied to the flow channel FC1, sample solution L1 that is not stored in the first wells W1 is washed away by the sealing liquid L2 and the sealing liquid L2 makes a substitute in the internal space S1.

The sealing liquid L2 thereby seals the respective first wells W1 individually and the first wells W1 that store the sample solutions L1 serve as isolated reaction spaces. The sample solution L1 replaced with the sealing liquid L2 and the redundant sealing liquid L2 are discharged from the outlet 212.

### (A3) Causing Target Substances to Release Target Molecules

Subsequently, the target substances M1 distributed to the respective first wells W1 are caused to release target molecules. Hereinafter, this process will be sometimes abbreviated as “process (A3)”.

A method for causing target substances to release target molecules is selected depending on the type of target substances of interest. For example, in a case where target substances are DNA or RNA, fragments (i.e., target molecules) may be obtained from one fragment by ultrasonic disruption or enzymolysis.

In a case where target substances are aggregates formed by hybridization of nucleic acids, the detection device 100 may be heated to separate the respective nucleic acids by thermal denaturation.

In a case where target substances are protein aggregates, the aggregates may be untangled by ultrasonic irradiation, enzymes that decompose protein may be used, or a reagent that breaks down protein aggregation may be added.

In a case where target substances are cells, the cells may be disrupted by ultrasonic waves or electrical stimulation may be given to disrupt the cell membranes.

As a specific method, the following method is exemplified.

First, beads are disposed in the first wells W1. The beads may be disposed in the first wells W1 in advance or may be added to a solution including cells and disposed in the first wells W1 along with the cells. The beads are not limited as long as the effects of an embodiment of the invention are not impaired and the beads each have a size that allows the bead to be disposed in the first well W1. A material of the beads may be silica or a magnetic material.

The beads preferably have a size of 50 nm to 500 μm, more preferably 100 nm to 100 μm, even more preferably 500 nm to 10 μm.

At least ten, or more, beads are preferably disposed in each of the first wells W1.

Next, the first wells W1 are isolated in process (A2) with both cells serving as target substances and beads in the first wells W1, and the cells are cultured. After the cells are cultured for a certain time, the detection device 100 is irradiated with ultrasonic waves. It is possible to disrupt, using the beads, the cell walls of the cells by vibrating the beads in the first wells W1 and release the contents of the cells into the first wells W1.

In addition, if the target substances M1 are cells, the cell membranes may be dissolved by using a reagent that dissolves cell membranes.

As a specific method, the following method is exemplified.

First, a solution including cells and a reagent (also referred to as a cell lysis solution) that dissolves cell membranes are mixed. The solution including cells and the cell lysis solution may be mixed before being injected into the detection device 100 or may be mixed in the detection device 100.

In a case where the solution including cells and the cell lysis solution are mixed in the detection device 100, a method is exemplified in which the solution including cells is first injected into the first wells W1 and the cell lysis solution is then injected into the first wells W1. A possible method for adding the cell lysis solution to the first wells W1 includes a method such as adding the cell lysis solution to the detection device 100 at a flow rate at which the cells disposed in the first wells W1 do not leave the first wells W1 or fixing the cells in the first wells W1.

The method for fixing cells in the first wells W1 may be a method in which capture substances of the cells are bound to the first wells W1 or a method in which particles to which capture substances are bound are disposed in the first wells W1. The “capture substances” include antibodies that are bound to cells. In a case where particles to which capture substances are bound are used, magnetic beads are preferably used as the particles and the particles in the first wells W1 are retained by magnetic force when adding a cell lysis solution to the first wells W1.

It is possible to use a surfactant, a commercially available reagent, or the like as the cell lysis solution.

After the cells and the cell lysis solution are added to the first wells W1, the first wells W1 are isolated in tep (A2) and reacted for a certain time to solve the cell membranes. This makes it possible to release the contents of the cells into the first wells W1.

In addition, the cells serving as target substances may be cultured in the first wells W1 for a certain time and secretions such as cytokines secreted from each of the cells may be detected as a target molecule.

### (A4) Distributing Target Molecules

Subsequently, the target molecules released to the sample solution L1 are distributed to the respective second wells W2 one by one. Hereinafter, this process will be sometimes abbreviated as “process (A4)”.

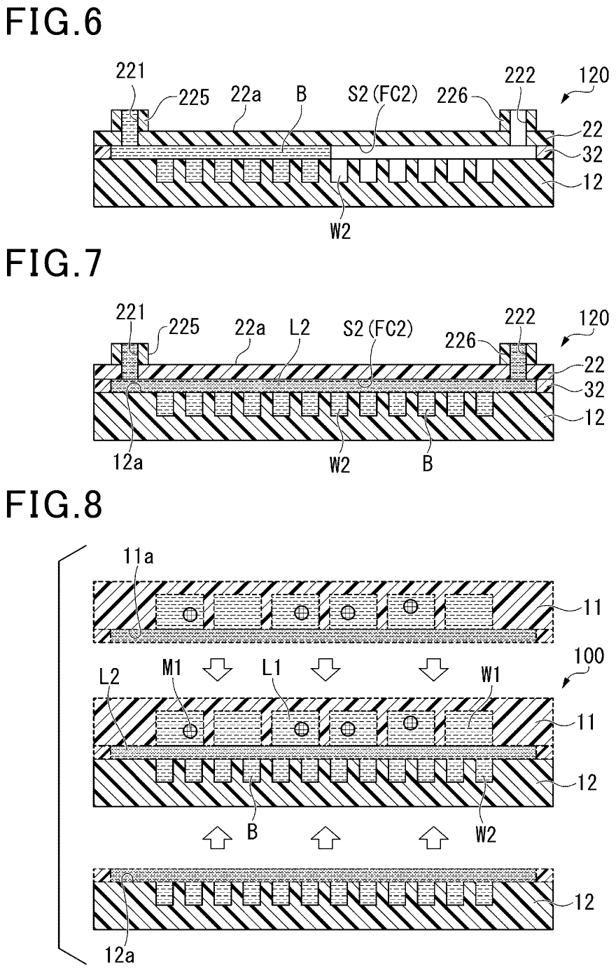

First, as illustrated in FIG. 6, a liquid buffer B is injected into the internal space S2 from the inlet 221 of the second member 120. The buffer B preferably includes a detection reagent for target molecules. When the buffer B flows in the internal space S2 (flow channel FC2), the second wells W2 open in the internal space S2 are each filled with the buffer B.

After the internal space S2 and all the second wells W2 are filled with the buffer B, buffer B passing through the flow channel FC2 is discharged from the outlet 222.

Subsequently, as illustrated in FIG. 7, the sealing liquid L2 is injected into the internal space S2 from the inlet 221. The sealing liquid L2 flows in the internal space S1 in the planar direction of the well forming surface 12a. Of the buffer B supplied to the flow channel FC2, buffer B that is not stored in the second wells W2 is washed away by the sealing liquid L2 and the sealing liquid L2 makes a substitute in the internal space S2.

It is possible to use, as the sealing liquid L2, the same sealing liquid as used in process (A2). The sealing liquid used in process (A2) and the sealing liquid used in this process may be the same or different. In a case where the sealing liquid used in process (A2) and the sealing liquid used in this process are different, it is sufficient if any one of the sealing liquids includes a surfactant.

The sealing liquid L2 hereby seals the respective second wells W2 individually and the second wells W2 in which the buffers B are stored are made independent. The buffer B replaced with the sealing liquid L2 and the redundant sealing liquid L2 are discharged from the outlet 222.

Subsequently, the first cover member 21 is detached from the first member 110 and the first member 110 is used as the first plate 11. In addition, the second cover member 22 is detached from the second member 120 and the second member 120 is used as the second plate 12. The well forming surfaces 11a and 12a of these well plates are covered with the sealing liquid L2.

Subsequently, as illustrated in FIG. 8, the well forming surface 11a of the first plate 11 and the well forming surface 12a of the second plate 12 that are opposed to each other are overlaid to form the detection device 100. In this case, the first wells W1 are disposed to overlap with the second wells W2 in plan view.

Furthermore, in the detection device 100, the first plate 11 and the second plate 12 are pressurized and pressed against each other and the well forming surface 11a and the well forming surface 12a are brought into contact. When the first plate 11 and the second plate 12 are pressed against each other, the first plate 11 and the second plate 12 may be directly pressed by a hand of an experimenter or may be pressed by using an instrument such as a clip or a roller. In addition, pressure to press the first plate 11 and the second plate 12 may be force provided by the experimenter or force provided using a jig such as a weight or a clip.

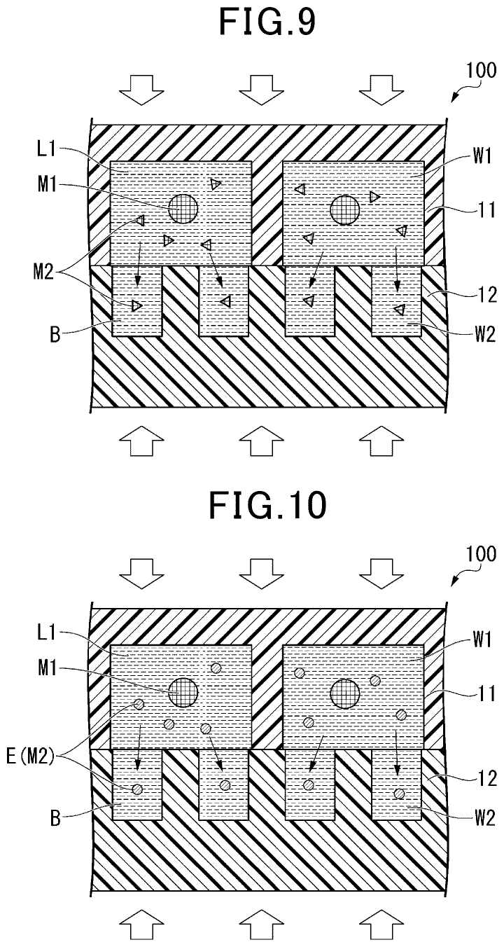

This provides communication between the first wells W1 and the second wells W2, and diffuses and migrates target molecules M2 in the first wells W1 to the second wells W2 as illustrated in FIG. 9.

It is confirmed that a sealing liquid including a surfactant effectively promotes the migration of substances from the first wells W1 to the second wells W2 in this process. In a case where the first plate 11 and the second plate 12 are pressed against each other as illustrated in FIG. 8, the sealing liquid L2 including a surfactant is lower in surface tension than the sealing liquid L2 including no surfactant and it is thought to be easier to penetrate the sealing liquid L2 between the first wells W1 and the second wells W2. This makes it easier to provide communication between the first wells W1 and the second wells W2 as illustrated in FIG. 9 and the migration of the substances from the first wells W1 to the second wells W2 is thought to be effectively promoted.

The target molecules M2 that migrate to the second wells W2 may be dissolved in the sample solutions L1 in the second wells W2 or captured by target molecule capture substances fixed in the second wells W2. Each of the target molecule capture substances may be a substance including a functional group that is specifically bound to the target molecule M2, for example, if the target molecule M2 is a protein, the target molecule capture substance may be an antibody, or if the target molecule M2 is a nucleic acid, the target molecule capture substance may be a nucleic acid that forms a complementary strand.

In addition, the target substances M1 may be caused to release the target molecules M2 with particles (capture particles below) including target molecule capture substances disposed in the first wells W1, and the capture particles may be caused to capture the released target molecules M2 in the first wells W1. The migration of the capture particles that have captured the target molecules M2 from the first wells W1 to the second wells W2 makes it possible to introduce the target molecules M2 to the second wells W2.

In a case where capture particles as described above are used, the capture particles may be caused to fall or rise by using the difference in specific gravity between the sample solution L1 and the capture particles and the capture particles may be migrated from the first wells W1 to the second wells W2. In addition, in a case where magnetic beads are used for the capture particles, the behavior of the capture particles may be controlled by using magnetic force from the outside of the detection device 100.

### (A5) Detecting Target Molecules

Subsequently, a reaction is produced between the target molecules M2 and a detection reagent to detect the target molecules M2. Hereinafter, this process will be sometimes abbreviated as “process (A5)”.

An example of the detection method includes a method in which a signal amplification reaction is produced in each of the sealed second wells W2. To detect signals originating from a detection reagent, the signals are amplified in the second wells W2.

Examples of the signals include fluorescence, color development, a potential change, a pH change, and the like.

The signal amplification reaction may be, for example, a biochemical reaction. More specifically, the signal amplification reaction may be an enzyme reaction. As an example, the signal amplification reaction is an isothermal reaction in which the detection device 100 is maintained with a reagent solution including enzymes for signal amplification stored in the second wells W2 for a predetermined time of, for example, at least 10 minutes and preferably about 15 minutes under a certain temperature condition of, for example, 60° C. or more and preferably about 66° C. under which desired enzyme activity is obtained.

In a case where the target molecules M2 are nucleic acids, specific examples of the signal amplification reaction include an ICA reaction such as an Invader (registered trademark) method, a loop-mediated isothermal amplification method (LAMP method (registered trademark)), a 5′ to 3′ nuclease method (TaqMan (registered trademark) method), a fluorescence probe method, and the like. These methods are each thought to make it possible to produce a signal amplification reaction even if a solution includes the surfactant (cell lysis solution) described above.

In addition, in a case where a cell lysis solution hinders a signal amplification reaction at the time of the reaction, the solutions in the second wells W2 may be replaced. In that case, the target molecules M2 may be fixed in the second wells W2 and a detection reagent may be then externally added.

As a method for fixing target molecules in the second wells W2, substances that capture the target molecules M2 may be bound to the inside of the second wells W2, or magnetic particles to which compounds that capture the target molecules M2 are bound may be added to the second wells W2 and the magnetic particles may be then fixed by magnetic force.

It is preferable in particular to use an ICA reaction as the signal amplification reaction. In the ICA reaction, signal amplification progresses through the two reaction cycles of (1) the complementary binding between nucleic acids and (2) the recognition and cleavage of a triple-stranded structure by enzymes. In such a signal amplification reaction, contaminants other than target molecules influence the reaction cycles less. Thus, even in a case where various components (contaminants) other than target molecules are present in the second wells W2, the use of an ICA reaction makes it possible to accurately detect the target molecules.

For example, in a case where an ICA reaction is used for the signal amplification reaction, the sample solution L1 includes a reaction reagent and template nucleic acids necessary for the ICA reaction. In a case where a biochemical reaction in a reaction process is an ICA reaction, fluorescent substances are released from quenching substances to emit predetermined fluorescence signals in response to excitation light in the second wells W2 in which target molecules are present.

In addition, it is also possible to detect the target molecules by binding substances (specific binding substances) specifically bound to the target molecules to the target molecules and detecting the bound specific binding substances. For example, in a case where the target molecules are proteins, it is possible to detect the target molecules using ELISA. More specifically, the target molecules may be detected using, for example, sandwich ELISA that uses the principle of FRET.

In a case where a sandwich method in which the principle of FRET is used, first specific binding substances (e.g., antibodies) and second specific binding substances are first prepared. The first specific binding substances are labeled with first fluorescent substances (i.e., donors). The second specific binding substances are labeled with second fluorescent substances (i.e., acceptors) having a light absorbing wavelength overlapping with the fluorescence wavelength of the first fluorescent substances.

Subsequently, target molecules (e.g., antigens) are brought into contact with both the first specific binding substances and the second specific binding substances to form complexes. When the complexes are formed, the distance between the donors and the acceptors decreases and the radiation of the excitation wavelength of the donors allows the fluorescence wavelength of the acceptors to be detected. Alternatively, the specific binding substances may be labeled with nucleic acid fragments and the nucleic acid fragments may be then detected through an ICA reaction.

It is possible to use something similar to a specific binding molecule for a structure described below as each specific binding substance, for example, it is possible to use an antibody, an antibody fragment, an aptamer, and the like. To detect the specific binding substances bound to target molecules, the specific binding substances may be directly or indirectly labeled, for example, by enzymes such as horseradish peroxidase (HRP). In a case where two or more specific binding substances are used, it is possible to label the respective specific binding molecules to allow the specific binding molecules to be identified.

It may be possible to select a publicly known appropriate method depending on the type of signals to be observed as a signal observation method. For example, in the case of bright field observation, a base member provided with a well array is irradiated with white light in the vertical direction. In the case of fluorescence signal observation, the inside of a well is irradiated with excitation light corresponding to fluorescent substances from the bottom side of the well and fluorescence emitted from the fluorescent substances is observed. An image of the whole or a portion of the observed well array is captured and stored, and image processing is performed by a computer system.

The detection device 100 configured as described above makes it possible to detect target molecules released from target substances in a solution with high sensitivity.

In addition, according to a target molecule detection method as described above, it is possible to analyze a target molecule released from one target substance. Furthermore, it is possible to analyze the characteristics of a target substance that releases a target molecule after the target molecule is detected, for example, such as detecting a cytokine and then analyzing the DNA or the RNA of a cell, or counting the number of sequences of specific DNA and then analyzing the entire DNA sequence. These make it possible to detect target molecules with high accuracy.

Process (A1) is performed in the present embodiment, but process (A1) may be omitted. In a case where process (A1) is not performed, it is favorable to extract, in process (A3), the first well W1 of the first wells in which the one target substance M1 is disposed after the first wells are filled with a sample solution, and then perform subsequent processes (A4) and (A5).

### Second Embodiment

FIGS. 10 to 13 are explanatory diagrams of a detection device included in a detection kit according to a second embodiment and a target molecule detection method. A component in the present embodiment common to a component in the first embodiment will be denoted by the same reference sign and detailed description thereof will be omitted.

### Detection Device

FIG. 10 is a cross-sectional view of a detection device 200 included in the detection kit according to the present embodiment taken along arrows and corresponds to FIG. 2.

The detection device 200 includes a first well plate 15, the second plate 12, and the wall member 13. The detection device 200 is used as a reaction container that stores a sample inside, causes target substances included in the sample to release target molecules, and produces detection reactions of the target molecules. In that case, the target substances included in the sample are caused to release the target molecules in the first well plate 15 and the target molecules migrating from the first well plate 15 are detected in the second plate 12.

The first well plate 15 and the second plate 12 are detachably stacked with the wall member 13 in between.

### First Well Plate

The first well plate 15 is a plate-shaped member having a rectangular shape in plan view. In the following description, the first well plate 15 will be sometimes abbreviated as the “first plate 15”.

The first plate 15 includes the first wells W1 on a well forming surface 15a that faces the inner surface of the detection device 200. Each of the first wells W1 is a recess provided on the well forming surface 15a of the first plate 15 and opens on the well forming surface 15a.

The first plate 15 has two through holes extending through the first plate 15 in the thickness direction. The two respective through holes are provided at one of the ends of the first plate 15 and the other end. One of the through holes is an inlet 151 used when a liquid material is injected into an internal space S of the detection device 200 and the other through hole is an outlet 152 used when the liquid material is discharged from the internal space S.

The inlet 151, the internal space S, and the outlet 152 are connected in this order to form a flow channel FC as a whole. In the detection device 200, a liquid material flows to the flow channel FC as appropriate and target substances are sealed in the first wells W1. The first plate 15 includes the first wells W1 between the inlet 151 and the outlet 152 in plan view.

The upper surface of the first plate 15 may include a tubular injection port that surrounds the inlet 151. In addition, the upper surface of the first plate 15 may include a tubular injection port that surrounds the outlet 152.

### Target Molecule Detection Method

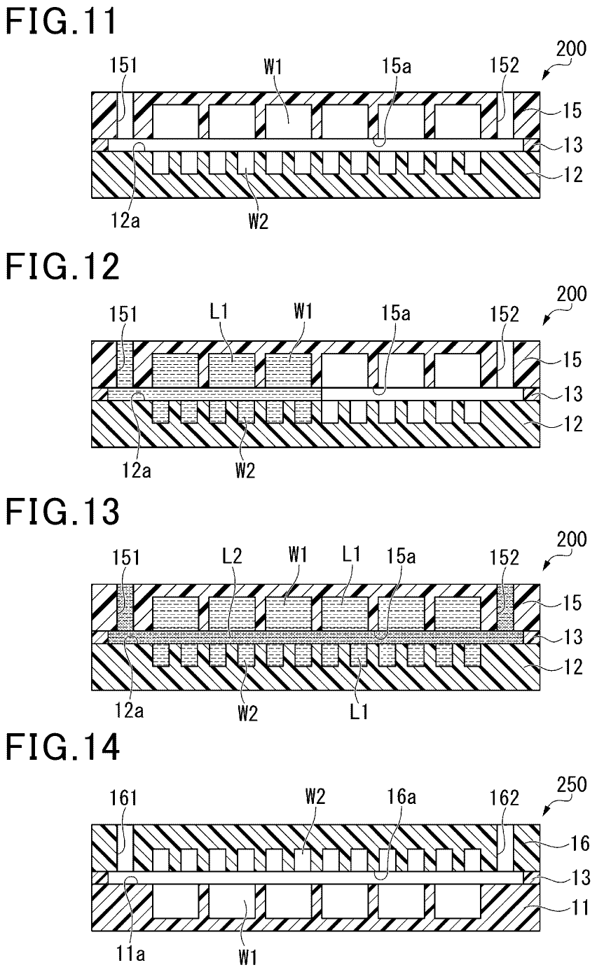

Each of FIGS. 11 to 13 is an explanatory diagram of a target molecule detection method according to the present embodiment. In the target molecule detection method according to the present embodiment, process (A1) to process (A5) described above are performed by using the detection device 200. Process (A1) is common to that of the first embodiment.

Subsequently, as illustrated in FIG. 11, the sample solution L1 including a detection reagent is injected into the internal space S (i.e., flow channel FC) from the inlet 151 and the first wells W1 open in the internal space S are each filled with the sample solution L1. At this time, the second wells W2 are also each filled with the sample solution L1.

Subsequently, as illustrated in FIG. 12, the sealing liquid L2 including a surfactant is injected into the internal space S (i.e., flow channel FC) from the inlet 151. The sealing liquid L2 flows in the internal space S in the planar direction of the well forming surface 11a, washes away the sample solution L1 not stored in the first wells W1 and the second wells W2 in the internal space S, and thereby replacing the contents of the internal space S.

The sealing liquid L2 hereby seals the first wells W1 and the second wells W2 individually (process (A2)). The sample solution L1 replaced with the sealing liquid L2 and the redundant sealing liquid L2 are discharged from the outlet 152.

Subsequently, the target substances M1 distributed to the respective first wells W1 are caused to release target molecules in accordance with the method described above (process (A3)).

Subsequently, the detection device 200 is pressed from both sides of the first plate 15 and the second plate 12 and the well forming surface 15a and the well forming surface 12a are brought into contact.

This provides communication between the first wells W1 and the second wells W2, and diffuses and migrates target molecules M2 in the first wells W1 to the second wells W2 as illustrated in FIG. 9 in the first embodiment (process (A4)).

Subsequently, reactions are produced between the target molecules M2 and a detection reagent in the second wells W2 to detect the target molecules M2 (process (A5)).

The detection device 200 configured as described above makes it possible to detect target molecules released from target substances in a solution with high sensitivity.

In addition, according to even a target molecule detection method as described above, it is possible to detect target molecules with high accuracy.

The detection device 200 according to the present embodiment has the inlet 151 and the outlet 152 on the first plate 15, but is not limited to this. As with a detection device 250 illustrated in FIG. 14, a first plate 11 and a second well plate 16 having an inlet 161 and an outlet 162 may be included.

The detection device 250 makes it possible to perform a target molecule detection method when used as with the detection device 200.

### Third Embodiment

FIGS. 14 to 17 are explanatory diagrams of a detection device included in a detection kit according to a third embodiment and a target molecule detection method. A component in the present embodiment common to a component in the first embodiment will be denoted by the same reference sign and detailed description thereof will be omitted.

### Fluid Device

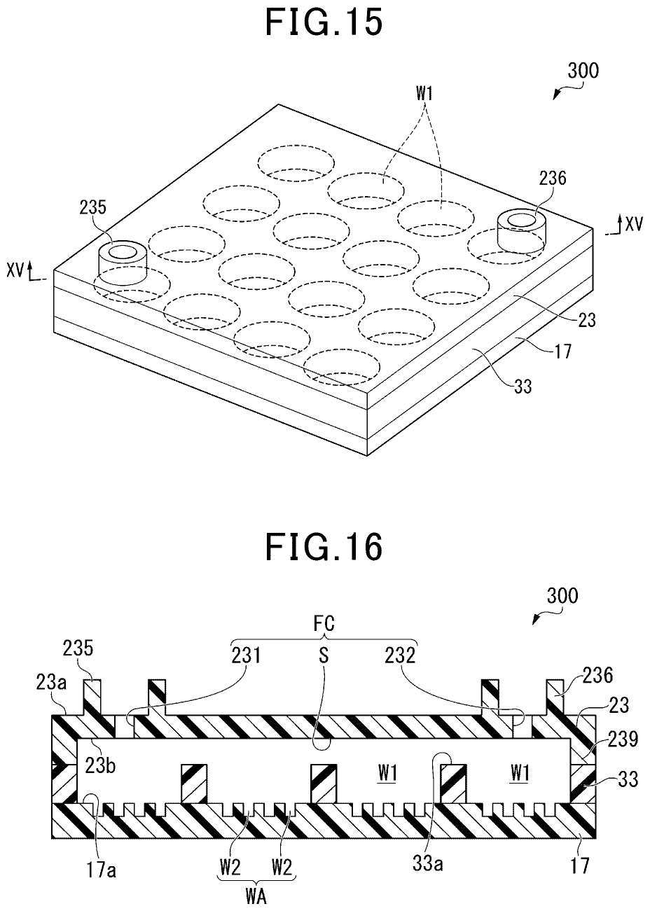

FIG. 14 is a schematic perspective view of a fluid device according to the present embodiment. FIG. 15 is a cross-sectional view taken along a line XV-XV of FIG. 14.

A fluid device 300 includes a well plate (also referred to as a substrate) 17, a cover member 23, and a wall member 33. The fluid device 300 includes the first wells W1 surrounded by the well plate 17 and the wall member 33 and the second wells W2 provided to the respective bottoms of the first wells W1. The second wells W2 serves as an upper surface 17a of the well plate 17.

### Well Plate

The well plate 17 is a plate-shaped member having a rectangular shape in plan view. The upper surface 17a of the well plate 17 is provided with the second wells W2.

It is possible to use, as a material of the well plate 17, the same material as the material of the first well plate 11 described above.

### Wall Member

The wall member 33 is formed to have a closed annular shape in plan view and disposed on the upper surface 17a of the well plate 17. The wall member 33 is sandwiched between the well plate 17 and the cover member 23 and integrated with the well plate 17 and the cover member 23 to form the fluid device 300. The space surrounded by the well plate 17, the cover member 23, and the wall member 33 is the internal space S in which a liquid sample is stored.

The wall member 33 functions as a wall surface of the internal space S and further functions as a spacer between the well plate 17 and the cover member 23.

The internal space S is defined by the wall member 33 and the first wells W1 is formed in the internal space S. The first wells W1 each refer to a space surrounded by the well plate 17, the wall member 33, and a virtual plane parallel with the a top 33a of the wall member 33 and in contact with the top 33a. The second wells W2 is disposed on the bottom of each of the first wells W1.

It is possible to adopt, as the material of the wall member 33, the same material as the material of the well plate 17 described above. It is possible to integrate the wall member 33 formed by using such a material with the well plate 17 and the cover member 23 by bonding the wall member 33 with an adhesive or welding the wall member 33 by thermal welding, ultrasonic welding, laser welding, and the like.

The wall member 33 may be formed to be integrated with the well plate 17 and included in a portion of the well plate 17. Similarly, the wall member 33 may be formed to be integrated with the cover member 23 and included in a portion of the cover member 23.

### Cover Member

The cover member 23 has the same outline shape as the outline shape of the well plate 17 in plan view. An outer edge section of a lower surface 23b of the cover member 23 is provided with a protrusion 239. The cover member 23 is connected to the wall member 33 with the protrusion 239 in between.

The cover member 23 has two through holes (an inlet 231 and an outlet 232) extending through the cover member 23 in the thickness direction. An upper surface 23a of the cover member 23 is provided with a tubular injection port 235 that surrounds the inlet 231. Similarly, the upper surface 23a of the cover member 23 is provided with a tubular discharge port 236 that surrounds the outlet 232.

It is possible to adopt, as the material of the cover member 23, the same material as the material of the first plate 11 described above. The material of the cover member 23 is preferably silicone resin. As the silicone resin, for example, PDMS may preferably be used.

The inlet 231, the internal space S, and the outlet 232 are connected in this order to form a flow channel FC as a whole. In the fluid device 300, a liquid material flows to the flow channel FC as appropriate to produce a detection reaction of target substances.

### Target Molecule Detection Method

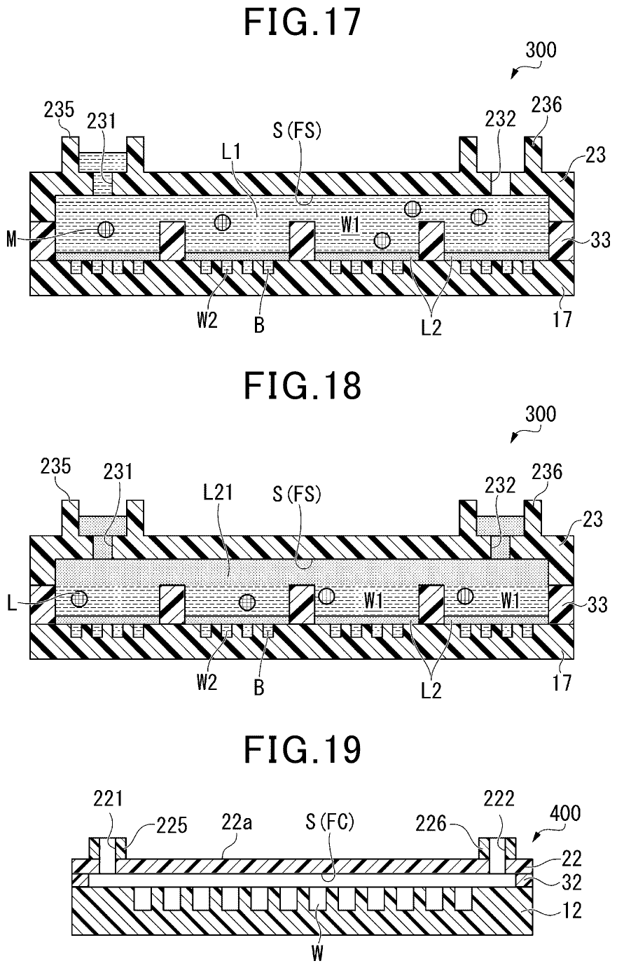

Each of FIGS. 16 to 17 is an explanatory diagram of a target molecule detection method according to the present embodiment. The target molecule detection method is performed by using the detection kit including the detection device 300 described above and includes the following processes of performing operations.
(B1) a process of isolating and sealing a buffer in each of second wells using sealing liquid;
(B2) a process of filling each of first wells with a sample solution including target substances and isolating and sealing the sample solution in each of the first wells;
(B3) a process of causing the target substances to release target molecules in the first wells;
(B4) a process of distributing the target molecules to the respective second wells one by one; and
(B5) a process of detecting the target molecules.

### (B1) Isolating and Sealing Buffer

As illustrated in FIG. 16, first, the second wells W2 of the detection device 300 are filled with the buffer B and the buffer B is isolated and sealed for each of the second wells W2 using the sealing liquid L2 including a surfactant.
(B2) Filling First Wells with Sample Solution

Subsequently, the sample solution L1 is obtained by adjusting the concentration of the liquid sample including the target substances. It is possible to prepare the sample solution L1 as in process (A1) described above. The sample solution L1 then includes no surfactant. Each of the first wells W1 is filled with the prepared sample solution L1.

First, as illustrated in FIG. 16, the sample solution L1 is injected into the internal space S from the inlet 231. When the sample solution L1 flows in the internal space S (flow channel FC), the sample solution L1 pushes away the buffer B in the internal space S and the first wells W1 open in the internal space S are each filled with the sample solution L1.

After the internal space S and all the first wells W1 are filled with the sample solution L1, the sample solution L1 passing through the flow channel FC is discharged from the outlet 232.

Subsequently, as illustrated in FIG. 17, after the internal space S is filled with the sample solution L1, sealing liquid L21 is supplied to the flow channel FC from the inlet 231. It is possible to use, as the sealing liquid L21, one described above as a sealing liquid. The viscosity of the sealing liquid L21 is lower than the viscosity of the sealing liquid L2.

The sealing liquid L21 supplied to the flow channel FC flows above the first wells W1 in the internal space S without entering the first wells W1, and of the sample solution L1 with which the internal space S is filled, the sample solution L1 that is not stored in the first wells W1 is washed away and the sealing liquid L21 replaces it.

The sealing liquid L21 hereby seals the respective first wells W1 individually and the first wells W1 that store the sample solutions L1 serve as isolated reaction spaces. The respective first wells W1 are independently filled with target substances included in the sample solution L1. The sample solution L1 replaced with the sealing liquid L21 and the redundant sealing liquid L21 are discharged from the outlet 232.

The first wells W1 may be sealed by using lipophilic liquid alone included in the sealing liquid L2.

### (B3) Causing Target Substances to Release Target Molecules

Subsequently, the target substances M1 distributed to the respective first wells W1 are caused to release the target molecules M2 as in process (A3) described above.

### (B4) Distributing Target Molecules

Subsequently, the detection device 300 is pressurized from both sides of the cover member 23 and the well plate 17 by pressing the cover member 23 and the well plate 17 against each other. This provides communication between the first wells W1 and the second wells W2 that have been isolated with the sealing liquid L2 in between, and diffuses and causes migration of target molecules M2 in the first wells W1 to the second wells W2.

### (B5) Detecting Target Molecules.

Subsequently, reactions are produced between the target molecules M2 and a detection reagent in the second wells W2 to detect the target molecules M2 as in process (A5) described above.

A kit including the detection device 300 configured as described above makes it possible to detect target molecules released from target substances in a solution with high sensitivity.

In addition, according to even a target molecule detection method as described above, it is possible to detect target molecules with high accuracy.

### Fourth Embodiment

Each of FIGS. 18 to 20 is an explanatory diagram of a target molecule detection method according to a fourth embodiment. The target molecule detection method is performed by using a detection kit including a detection device 400 and includes the following processes of performing operations.
(C1) a process of adjusting W/O type emulsion obtained by dispersing droplets including target substances in lipophilic liquid;
(C2) a process of isolating and sealing a buffer in each of wells by liquid including lipophilic liquid;
(C3) a process of causing the emulsion to flow to a flow channel and replacing the liquid including the lipophilic liquid with the emulsion;
(C4) a process of causing the target substances in the droplets to release target molecules;
(C5) a process of pressurizing the emulsion through a cover member and distributing the droplets to respective isolated first wells from the emulsion; and
(C6) a process of detecting the target molecules.

FIG. 19 is a schematic cross-sectional view of the detection device 400. As illustrated in FIG. 19, the detection device 400 is a member having the same configuration as the configuration of the second member 120 described in the first embodiment and includes the well plate 12, the cover member 22 opposed to the well plate 12, and the wall member 32 sandwiched between the well plate 12 and the cover member 22. The well plate 12, the cover member 22, and the wall member 32 have configurations similar to the configurations of the respective members of the second member 120 described in the first embodiment. FIG. 19 uses the same reference number as the reference number of the second member 120.

Wells of the well plate 12 are each denoted by the reference sign “W”. The wells W each correspond to a first well according to an embodiment of the present invention.

The well plate 12 is a member having the same configuration as the configuration of the second member 120 described above. The well plate 12 includes the wells W (i.e., first wells).

Similarly, the cover member 22 is a member having the same configuration as the configuration of the second cover member 22 described above and the wall member 32 is a member having the same configuration as the configuration of the second wall member 32 described above.

### (C1) Adjusting W/O Type Emulsion

First, target substances and sealing liquid (that is, a mixed solution of a surfactant and lipophilic liquid) are used to adjust W/O type emulsion in which droplets including the target substances are dispersed in the lipophilic liquid. To adjust the water-in-oil droplets of the W/O type emulsion, it may be possible to adopt, for example, a publicly known method used for microbial cultivation or a digital PCR method.

When the emulsion is adjusted, the concentration of the target substances, the concentration of the surfactant, the amount of the surfactant relative to the target substances, or the like is adjusted such that one of the droplets included in the emulsion includes zero or one target substance. That is, in this process, a target substance is distributed to each of the droplets included in the emulsion.
(C2) Isolating and Sealing Buffer

Subsequently, as illustrated in FIG. 19, the wells W of the detection device 400 are each filled with the buffer B and each of the wells W is isolated and sealed by liquid L3 including lipophilic liquid.

The liquid L3 used for sealing may be the same as a dispersion medium of the emulsion or different from a dispersion medium of the emulsion. The dispersion medium of the emulsion is lipophilic liquid of sealing liquid used to prepare the emulsion. For example, it is possible to use fluorine-based oil as the dispersion medium of the emulsion and use silicone-based oil as the liquid L3 used for sealing.

In addition, the liquid L3 may or may not include a surfactant as long as the effects of an embodiment of the invention are not impaired. In a case where the liquid L3 includes a surfactant, the liquid L3 may be the same as the sealing liquid described above or different.

### (C3) Causing Emulsion to Flow to Flow Channel

Subsequently, emulsion E is injected from the inlet 221, the emulsion E fabricated in process (C1) is caused to flow to the flow channel FC of the detection device 400, and the liquid L3 in the flow channel FC is replaced with the emulsion E. The liquid L3 that seals the wells W is left behind and the redundant liquid L3 is discharged from the flow channel FC, and so the flow channel FC is filled with the emulsion E.

### (C4) Causing Target Substances to Release Target Molecules

Subsequently, a target substance distributed to each of droplets included in the emulsion E is caused to release target molecules in the droplet.

It is possible to adopt the following method as a method for causing target molecules to be released.

In a case where the target substances are DNA or RNA, restriction enzymes are added into the emulsion and nucleic acids are cleaved for each specific sequence to make it possible to release nucleic acids serving as the target molecules into droplets in the emulsion.

In a case where target substances are secreted from cells, the cells are cultured in the emulsion for a certain time to make it possible to release the secretion serving as the target molecules into droplets in the emulsion.

### (C5) Pressurizing Emulsion

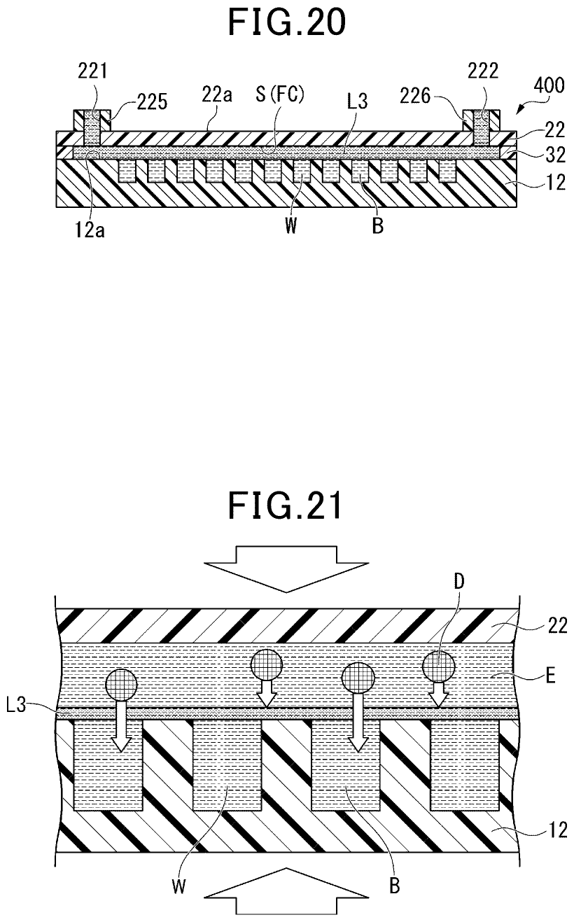

Subsequently, as illustrated in FIG. 20, the detection device 400 is pressurized from both sides of the cover member 22 and the well plate 12 by pressing the cover member 22 and the well plate 12 against each other. This causes droplets D in the emulsion E to migrate to the wells W and unites the droplets D within the wells W. Target substances and target molecules present in the droplets D are diffused in the buffers B in the wells W.

In a case where the target substances are substances in cells, a reagent that dissolves cell membranes is included in the buffer B in each of the wells W to make it possible to disperse the contents of the cell in the well W. The reagent that dissolves cell membranes includes the anionic surfactant described above.

### (C6) Detecting Target Molecules

Subsequently, reactions are produced between the target molecules and a detection reagent dispersed in the wells W to detect the target molecules as in process (A5) described above. The detection reagent is preferably disposed in each of the wells W in advance.

A kit including the detection device 400 configured as described above makes it possible to detect target molecules released from target substances in a solution with high sensitivity.

In addition, according to even a target molecule detection method as described above, it is possible to detect target molecules with high accuracy.

### Fifth Embodiment

A target molecule detection method according to the present embodiment will be described by using FIGS. 4 to 8 and 10. The target molecule detection method includes the following processes of performing operations. In the target molecule detection method, the detection device 100 is used to detect target molecules included in a sample in the second wells W2 of the detection device 100.
(AA1) a process of obtaining a sample solution by adjusting the concentration of a liquid sample including target substances;
(AA2) a process of isolating and sealing the sample solution in first wells by sealing liquid;
(AA3) a process of obtaining evaluation targets in the first wells;
(AA4) a process of distributing the evaluation targets to the respective second wells one by one; and
(AA5) a process of detecting the target molecules.
(AA1) Obtaining Sample Solution

Hereinafter, this process will be sometimes abbreviated as “process (AA1)”. In the following description, the respective processes will be sometimes abbreviated similarly. Process (AA1) is different from process (A1) in the following points, but the other points are the same and description thereof will be thus omitted.

A sample may include a surfactant and the surfactant includes that have been described in the first embodiment. The surfactant preferably has a concentration of 0.0011 g/L or more and 55.5 g/L or less (0.0001 to 5 vol % [v/v]) relative to the total volume of the sample, more preferably 0.0111 g/L or more and 22.2 g/L or less (0.001 to 2 vol % [v/v]), and still more preferably 0.111 g/L or more and 11.1 g/L or less (0.01 to 1 vol % [v/v]).

If the surfactant has a concentration of 55.5 g/L or less relative to the total volume of the sample, a subsequent reaction for detecting target molecules is less influenced.

The concentration of the sample is adjusted to a concentration at which one target substance M1 is disposed for each of the first wells on the basis of the capacity of the fluid device to be used. The concentration of the sample is preferably determined by conducting a preliminary experiment with the fluid device.

In addition to the preliminary adjustment of the concentration of target substances to be introduced, a process for making the target substances visible may be conducted. Such a process makes it possible to extract only first wells including only one target substance in a subsequent process and use the extracted first well as a measurement target. It may be possible to extract a first well, for example, by capturing an enlarged image with a microscope and analyzing the obtained image with publicly known detection software.

If the target substances are cells, the cells may be detected in a bright field image of the microscope with no processing or may be stained using a trypan blue solution or the like. If target substances are nucleic acids, the nucleic acids may be caused to emit light by a publicly known fluorescent staining method or a method such as an ICA reaction and a well including one nucleic acid molecule may be identified on the basis of the intensity of the fluorescence. In a case where target substances are nucleic acids, it is possible to obtain fragments of the nucleic acids as target molecules, for example, by cleaving the nucleic acids with restriction enzymes.
(AA2) Isolating and Sealing Sample Solution

Subsequently, the first wells W1 is each filled with the sample solution L1 independently. Hereinafter, this process will be sometimes abbreviated as “process (AA2)”. The detection device 100 is divided into the first member 110 and the second member 120 and the first member 110 is then used in this process.

As illustrated in FIG. 4, a process of injecting the sample solution L1 including a detection reagent into the internal space S1 from the inlet 211 is the same as process (A2) and description thereof will therefore be omitted.

Subsequently, as illustrated in FIG. 5, the sealing liquid L2 is injected into the internal space S1 from the inlet 211. In addition, after the first cover member 21 is removed, the sealing liquid L2 may be dropped on the first wells W1 of the first plate 11 to seal the respective first wells W1. A solution above the first wells W1 may be scraped off by a spatula or the like and the sealing liquid L2 may be then dropped to isolate the respective first wells W1.

The sealing liquid L2 described above may be used as the sealing liquid L2. The sealing liquid L2 may be lipophilic liquid and does not have to include any surfactant.

The sealing liquid L2 hereby seals the respective first wells W1 individually and the first wells W1 that store the sample solutions L1 serve as isolated reaction spaces. The sample solution L1 replaced with the sealing liquid L2 and the redundant sealing liquid L2 are discharged from the outlet 212.
(AA3) Obtaining Evaluation Targets

Subsequently, a particulate evaluation target including target molecules is obtained from the target substance M1 distributed to each of the first wells W1. Hereinafter, this process will be sometimes abbreviated as “process (AA3)”.

A method for obtaining evaluation targets from target substances is selected depending on the type of target substances of interest.

For example, a target substance may be caused to release a target molecule to be evaluated and the obtained target molecule may be captured by a capture particle described below to obtain the evaluation target.

For example, in a case where target substances are DNA or RNA, fragments (i.e., target molecules) may be obtained from one fragment by ultrasonic disruption or enzymolysis.

In a case where target substances are associated bodies produced by the hybridization of nucleic acids, the detection device may be heated to separate the respective nucleic acids by thermal denaturation.

In a case where target substances are protein aggregates, the aggregates may be untangled by ultrasonic irradiation, enzymes that decompose protein may be used, or a reagent that breaks down protein aggregation may be added.

In a case where target substances are cells, the cells may be disrupted by ultrasonic waves or electrical stimulation may be given to disrupt the cell membranes.

In addition, cells serving as target substances may be cultured in the first wells for a certain time and secretion such as cytokine secreted from each of the cells may be detected as a target molecule.

The capture particle includes a particle and a part to which a target molecule is specifically bound.

The particle is not limited in particular and includes a polymer particle, a magnetic particle (a particle including a magnetic material), a glass particle, and the like. As the particle, a particle subjected to surface treatment to avoid nonspecific adsorption is preferable. In addition, to fix the specific binding substance, a particle including a functional group such as a carboxyl group on the surface is preferable. More specifically, it is possible to use “Magnosphere LC300” (product name) manufactured by JSR Corporation, or the like.

It is possible to select a part to which a target molecule is specifically bound from a group similar to the specific binding substances described above depending on the type of target molecules to be captured.

The capture particle preferably has a radius of 0.5 μm or more and 2.5 μm or less, and more preferably 1 μm or more and 2 μm or less.

When water has a density of 1 g/ml (g/cm³)) at 20° C., the density of the capture particle may be greater than or less than the density of water. For example, the capture particle may have a density of 0.7 g/cm³ or more and 1.3 g/cm³ or less or 0.8 g/cm³ or more and 1.2 g/cm³ or less.
(AA4) Distributing Evaluation Targets

Subsequently, the evaluation targets in the sample solution L1 are distributed to the respective second wells W2 for each molecule. Hereinafter, this process will be sometimes abbreviated as “process (AA4)”.

Process (AA4) is different from process (A4) in the following points, but the same in the other points and description thereof will be thus omitted.

The first wells W1 and the second wells W2 are in communication and evaluation targets E in the first wells W1 migrate to the second wells W2 as illustrated in FIG. 10 through a process described in process (A4). The evaluation targets E each include the target molecule M2.

The study has revealed that it is not possible to migrate evaluation targets to the second wells W2 in this process if the contact time of the well forming surface 11a and the well forming surface 12a is short. Meanwhile, to use various samples and evaluation targets, an appropriate index is necessary to appropriately migrate the evaluation targets. In addition, if the well forming surface 11a and the well forming surface 12a are left in contact for a long time, it is thought that evaluation targets will eventually migrate from the first wells W1 to the second wells W2, but it is necessary to appropriately manage the time for working efficiency.

The study based on the above has revealed that it is possible to appropriately cause migration of evaluation targets by keeping the well forming surface 11a and the well forming surface 12a in contact for a time longer than a contact time T expressed by the following Equation (1).

$$T = d 1 / v \qquad ( 1 )$$

(t (unit: Sec) Represents the Contact Time,
d1 (unit: μm) represents a diameter of an evaluation target, and
v (unit: μm/sec) represents a migration speed at which the evaluation target migrates from the first well to the second well in the sample solution).

In addition, it is preferable that the contact time T be longer than the time expressed by the following Equation (1)-1.

$$T = d 2 / v \qquad ( 1 ) - 1$$

(d2 (unit: μm) represents the distance from the bottom surfaces of the first wells to the surface on which the second wells are formed when the surface on which the first wells are formed and the surface on which the second wells are formed are brought into contact).

The detection device 100 may be left at rest and evaluation targets may migrate in the first wells closer to the surface on which the first wells are formed before the surface on which the first wells are formed and the surface on which the second wells are formed are brought into contact. The duration for which the detection device 100 is left at rest in this case is preferably set using the migration speed v, depending on the depth of the first wells W1. For example, in a case where H represents the depth of the first wells W1, it is possible to obtain the time for evaluation targets to migrate to the intermediate positions of the first wells W1 in the depth direction as H/(2·v).

In addition, it is possible to determine that a sufficient time is secured if the upper limit value of the contact time T is twice (2T) as great as the obtained contact time T. There is no problem if the contact time exceeds 2T.

In a case where the detection device is left at rest and evaluation targets migrate, the migration speed v in Equation (1) is a speed expressed by the following Equation (2).

$$v = [ 2 g \cdot {r}^{2} \cdot \vert ρ - ρ s \vert ] / 9 η \qquad ( 2 )$$

(g represents gravitational acceleration (unit: cm/s²), r represents a radius (unit: cm) of the evaluation target, ρ represents density (unit: g/cm³) of the evaluation target, ρs represents density (unit: g/cm³) of the sample solution, and η represents viscosity (unit: g/(cm·s)) of the sample solution).

In a case where the density of an evaluation target is greater than the density of a sample solution (ρ>ρs), the detection device is left at rest with the second wells located downward in the direction of gravity and the migration speed is obtained on the basis of Equation (2).

In a case where the density of an evaluation target is less than the density of a sample solution (ρ<ρs), the detection device is left at rest with the second wells located upward in the direction of gravity and the migration speed is obtained on the basis of Equation (2).

The density ρs of a sample solution is density at 20° C. In a case where the density ρs approximates the density of water, the density ρs is 0.998 g/cm³ and 1 g/cm³ is used as an approximate value.

The viscosity η of a sample solution is viscosity at 20° C. In addition, 1 g/(cm·s)=100 mPa/s is satisfied for the viscosity η. In a case where the viscosity η approximates the viscosity of water, 1 mPa·s=0.01 g/(cm·s) is satisfied for the viscosity η.

The physical properties of the component having the highest volume ratio of the respective components included in a sample solution is adopted as the physical properties of the sample solution. For example, in a case where a biological sample is a sample solution, an aqueous solution such as a buffer is used for the sample solution. In this case, the physical properties of water are adopted as the physical properties of the sample solution.

In a case where evaluation targets are capture particles that capture target molecules, it is possible to adopt the radius of each of the capture particles as r and the density of each of the capture particles as ρ.

In a case where evaluation targets are cells, the short diameter of each of the cells is adopted as r. In addition, 1.05 is used as an approximate value of ρ.

As the short diameter of a cell, an enlarged image (magnification: power of 4 to 20 times) of the cell is captured by using a microscope before evaluation and the short diameter of each of cells included in an image obtained with image analysis software is measured. In this case, the “length of a short side” of the “smallest rectangle of rectangles circumscribed about the cell” is used as the short diameter of the cell. The short diameters of all the cells included in the captured image are measured and the average value is adopted as r.

To obtain the average value of the short diameters of the cells, the short diameters of ten or more cells are measured in accordance with the method. In a case where one enlarged image includes less than ten cells, enlarged images is used to measure the short diameters of all the cells included in the respective enlarged images until ten or more cells are reached in total, and the average value of the short diameters is calculated.

In a case where a magnetic material is used for capture particles, it is favorable to migrate evaluation targets by applying magnetic force to the capture particles from the outside of the detection device 100. In this case, the migration speed v in Equation (1) is obtained by using, instead of g in Equation (2), acceleration generated in the capture particles at the midpoints between the bottoms of the first wells W1 and the bottoms of the second wells W2 when the magnetic force is applied to the capture particles. It may possible to calculate the acceleration using a publicly known method on the basis of the magnetic force applied to the capture particles and the physical properties of the capture particles.

Evaluation targets may be migrated by applying, to the detection device, centrifugal force exerted from the first well W1 side to the second well W2 side. In this case, the migration speed v in Equation (1) is obtained by obtaining centrifugal acceleration on the basis of operation conditions (the rotation speed and the radius of rotation) of a centrifuge to be used and using the obtained centrifugal acceleration instead of g in Equation (2).

### (AA5) Detecting Target Molecules

Subsequently, a reaction is produced between the target molecules and a detection reagent to detect the target molecules included in the evaluation targets. Hereinafter, this process will be sometimes abbreviated as “process (AA5)”.

The detection reagent may be disposed in the second wells W2 in advance or may be added afterward.

In a case where the evaluation targets are cells, the cells in the second wells W2 are preferably cultured for a certain period and the cells are then caused to release target molecules.

As a detection method, it is possible to use the method described in process (A5).

According to a target molecule detection method as described above, it is possible to detect target molecules with high accuracy.

Process (AA1) is performed in the present embodiment, but process (AA1) may be skipped. In a case where process (AA1) is not performed, it is favorable to extract, in process (AA3), the first well W1 of the first wells in which the one target substance M1 is disposed after the first wells are filled with a sample solution, and then perform subsequent processes (AA4) and (AA5).

In addition, the detection device 100 described in the present embodiment is only an example and it is possible to use a detection device having another configuration. For example, it is possible to perform the target molecule detection method according to the present embodiment by using the detection device 200 described in the second embodiment.

### Target Molecule Detection Method

Each of FIGS. 12 to 14 is an explanatory diagram of a target molecule detection method in which the detection device 200 is used. In a case where the detection device 200 is used, process (AA1) is first performed as described above.

Subsequently, as illustrated in FIG. 11, the sample solution L1 including a detection reagent is injected into the internal space S (flow channel FC) from the inlet 151 and the first wells W1 open in the internal space S are each filled with the sample solution L1. At this time, the second wells W2 are also each filled with the sample solution L1.

Subsequently, as illustrated in FIG. 12, the sealing liquid L2 including a surfactant is injected into the internal space S (flow channel FC) from the inlet 151. The sealing liquid L2 flows in the internal space S in the planar direction of the well forming surface 11a, washes away the sample solution L1 not stored in the first wells W1 and the second wells W2 in the internal space S, and thereby replacing the contents of the internal space S.

The sealing liquid L2 hereby seals the first wells W1 and the second wells W2 individually (process (AA2)). The sample solution L1 replaced with the sealing liquid L2 and the redundant sealing liquid L2 are discharged from the outlet 152.

Thereafter, processes (AA3) to (AA5) are performed in accordance with the method described above to allow target molecules to be detected.

The detection device 200 has the inlet 151 and the outlet 152 on the first plate 15, but this is not a limitation. As with the detection device 250 illustrated in FIG. 14, the first plate 11 and the second well plate 16 having the inlet 161 and the outlet 162 may be included.

Even if the detection devices 200 and 250 like these are each used to perform a target molecule detection method, it is possible to detect target molecules with high accuracy.

### EXAMPLES

Next, Examples will be used to describe the present invention in more detail, but the present invention is not limited to the following Examples.

### Manufacture of Detection Device

In the present Example, the detection device 100 according to the first embodiment described above was used as a detection device. First, the first plate 11 and the second plate 12 were fabricated by injection molding. Similarly, the first cover member 21 and the second cover member 22 were fabricated by injection molding. Cycloolefin polymers were used as materials for forming.

In the first plate 11, first wells each had an opening diameter (long diameter) of 50 μm and the first wells W1 each had a depth of 50 μm. Each first well W1 had a volume of 98 pL.

In the second plate 12, the second wells W2 each had an opening diameter (long diameter) of 10 μm and the second wells W2 each had a depth of 15 μm. Each second well W2 had a volume of 1100 fL.

A double-sided tape (manufactured by Nitto Denko Corporation) was used to bond the first plate 11 and the first cover member 21, and the first plate 11 and the first cover member 21 were used as the first member 110. Similarly, a double-sided tape (model number: No. 5610BN manufactured by Nitto Denko Corporation) was used to bond the second plate 12 and the second cover member 22, and the second plate 12 and the second cover member 22 were used as the second member 120.

### Capture Particle and Preparation of Capture Particle Solution

Cytokine capture antibodies (Anti-Mouse IL-2 MAb (Clone JES6-1A12), model number: MAB702-100, and R&D Systems, Inc) were bound to magnetic beads (MS300/Carboxyl manufactured by JSR Corporation).

The magnetic beads to which cytokine capture antibodies were bound were added to pure water to prepare a magnetic bead solution. The magnetic beads to which the cytokine capture antibodies were bound each correspond to a “capture particle”.

In the present Example, a simple evaluation of confirming the effects of an embodiment of the present invention was made by confirming the migration of the capture particles from the first plate 11 to the second plate 12.

### Example 1A and Comparative Example 1A

The first member 110 was filled with pure water. The second member 120 was filled with PBS-T (Tween 20 having 0.05 vol %).

Subsequently, the bead solution described above was added such that the first member 110 had a capture particle additive amount of 4×10⁶.

Subsequently, the first member 110 was filled with 500 μL of sealing liquid and beads were sealed in the first wells W1 (see FIG. 5). Similarly, the second member 120 was filled with 500 μL of sealing liquid and the sealing liquid sealed the second wells W2.

In the Example, FC-40 including a saturation concentration of Tween 20 was used as sealing liquid (sealing liquid 1).

In the comparative example, FC-40 not including Tween 20 was used as sealing liquid (sealing liquid 2).

The first plate 11 and the second plate 12 were respectively detached from the first member 110 and the second member 120. 100 μL of sealing liquid (the sealing liquid 1 in Example 1A and the sealing liquid 2 in comparative example 1A) was added to each of the well forming surfaces (state A).

The respective well forming surfaces were brought into contact with the well forming surface 11a of the first plate 11 facing downward in the vertical direction and the well forming surface 12a of the second plate 12 facing upward in the vertical direction, and used as a detection device. Both well plates were bonded by being pressed against each other for six seconds (see FIGS. 8 and 9). Both well plates were pressurized by being pinched by the fingers of an experimenter. The capture particles are thought to migrate from the first wells W1 to the second wells W2 in this operation.

The detection device was divided into the first plate 11 and the second plate 12 and 100 μL of the sealing liquid (the sealing liquid 1 in Example 1A and the sealing liquid 2 in the comparative example 1A) was added to each of the well forming surfaces. The second cover member 22 was bonded again to the second plate 12 and used as the second member 120.

Furthermore, 200 μL of FC-40 alone was added from the inlet 221 of the second member 120 (state B).

The first plate 11 and the second plate 12 in state A and the second plate 12 in state B were observed with a microscope. The devices used were as follows.

Microscope: BZ-800 (manufactured by KEYENCE CORPORATION); and

Objective lens: CFI Plan Apochromat Lambda 10X (manufactured by NIKON CORPORATION).

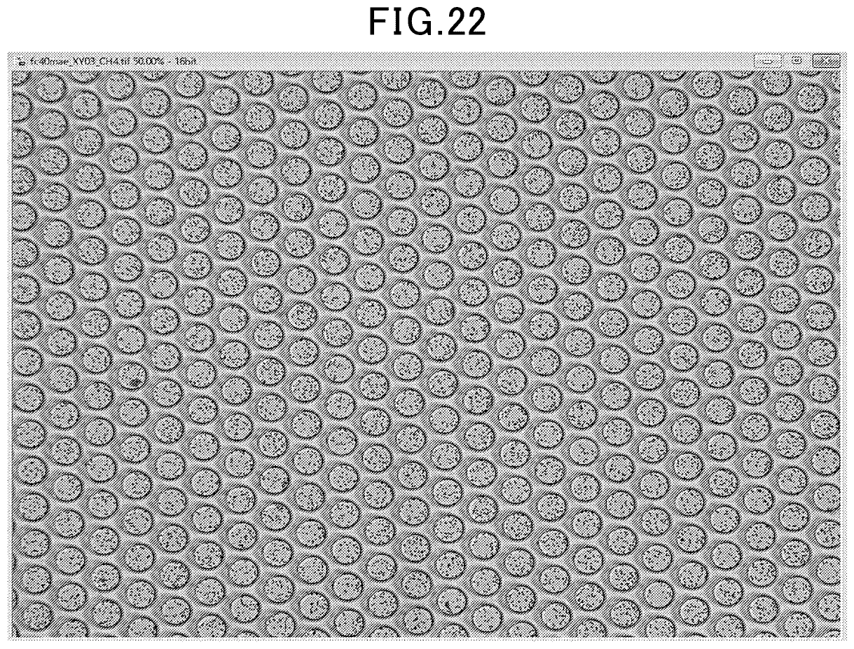

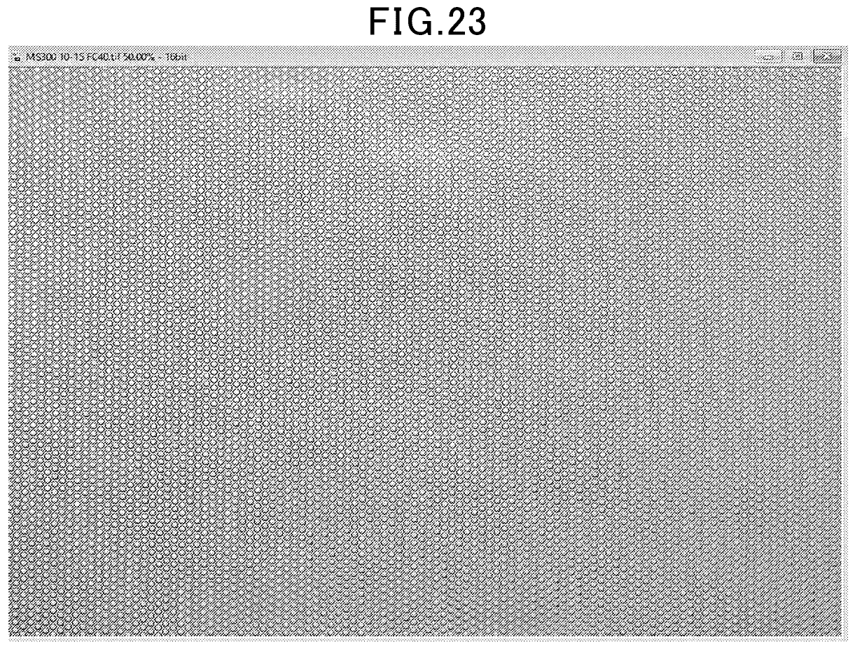

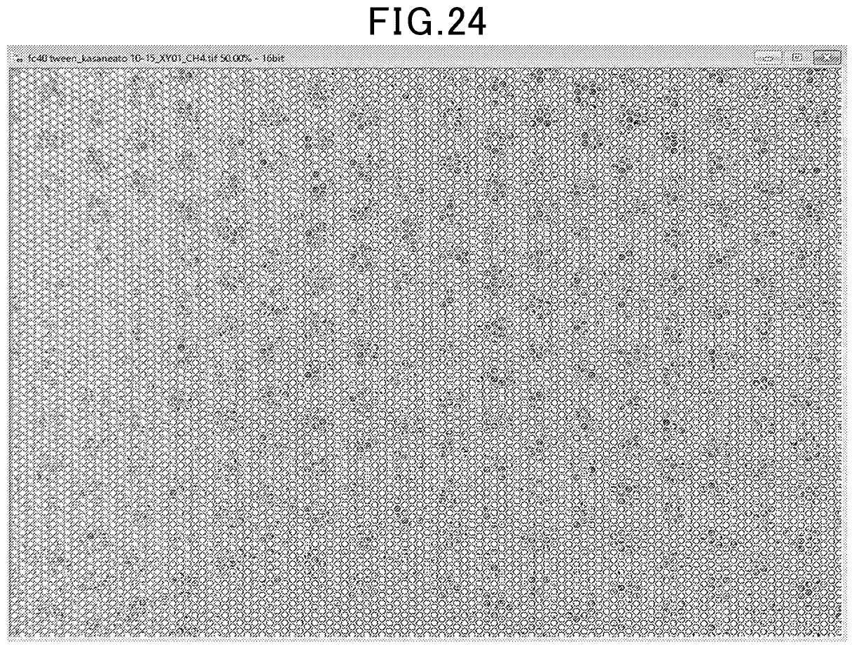

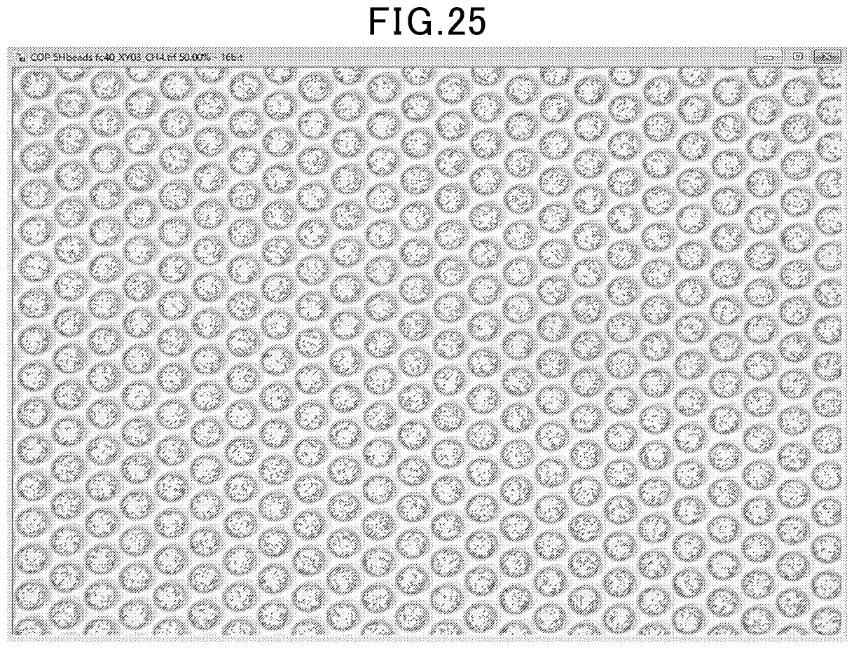

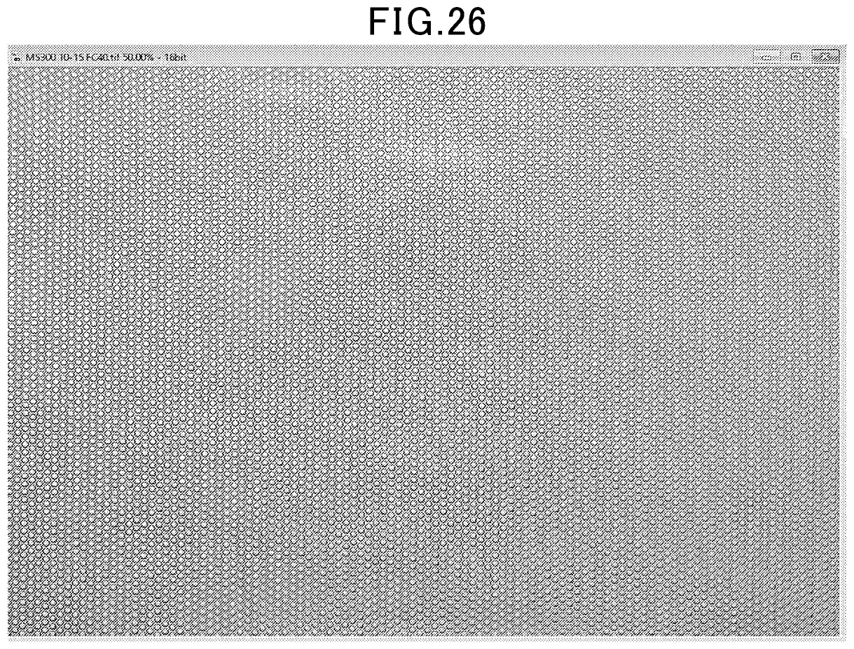

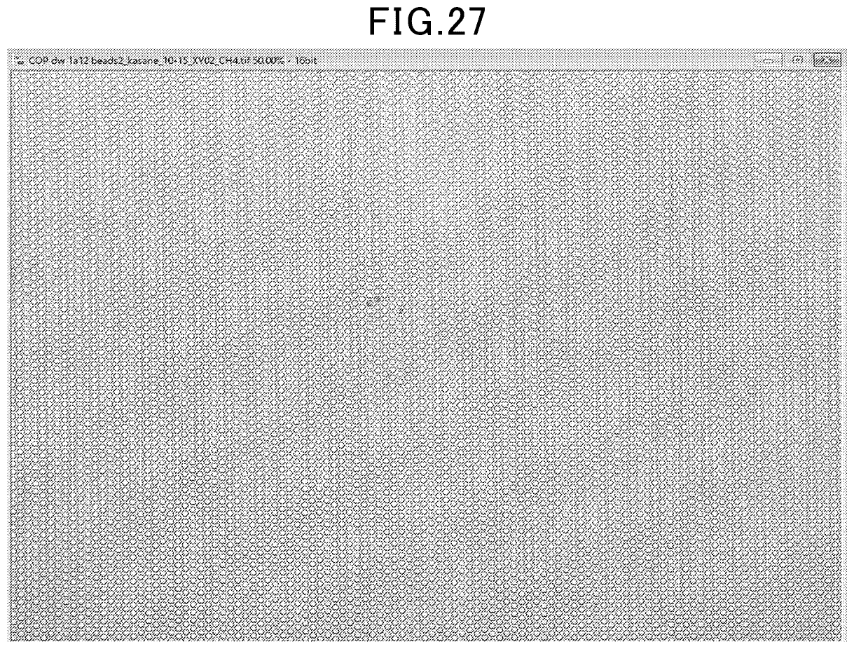

Each of FIGS. 22 to 24 is an enlarged photograph illustrating a result of an Example. Each of FIGS. 25 to 27 is an enlarged photograph illustrating a result of a comparative example. FIGS. 22 and 25 are enlarged photographs of the first plate 11 in state A, FIGS. 23 and 26 are enlarged photographs of the second plate 12 in state A, and FIGS. 24 and 27 are enlarged photographs of the second plate 12 in state B.

A result of an experiment confirmed that beads were present in the second plate 12 in state B in a mottled manner in Example 1A as illustrated in FIG. 24. That is, it is thought that beads migrated to the second wells having positions overlapping with the positions of the first wells in a mottled manner as a result of the migration of the beads sealed in the first wells of the first plate 11 to the second wells of the second plate 12 in the Example in which the sealing liquid 1 including a surfactant was used.

In contrast, the migration of beads was not substantially confirmed in the second plate 12 in the state B as illustrated in FIG. 27 in the comparative example 1A.

The results above confirmed that an embodiment of the present invention was effective.

### Experimental Example 1B

The first member 110 was filled with pure water. Subsequently, the magnetic bead solution described above was added such that the first member 110 had a capture particle additive amount of 1×10⁶. Furthermore, the first member 110 was filled with 500 μL of FC-40 as sealing liquid.

The second member 120 was filled with 100 μL of pure water. Subsequently, the second member 120 was filled with 200 μL of FC-40 as sealing liquid.

The first plate 11 and the second plate 12 were respectively detached from the first member 110 and the second member 120. 100 μL of sealing liquid was added to each of the well forming surfaces (state A).

The respective well forming surfaces were brought into contact with the well forming surface 11a of the first plate 11 facing downward in the vertical direction and the well forming surface 12a of the second plate 12 facing upward in the vertical direction, and used as a detection device. Both well plates were bonded by being pressed against each other for six seconds (see FIGS. 8 and 10). Both well plates were pressurized by being pinched by the fingers of an experimenter.

The detection device was divided into the first plate 11 and the second plate 12 and 100 μL of the sealing liquid was added to each of the well forming surfaces. The second cover member 22 was bonded again to the second plate 12 and used as the second member 120.

Furthermore, 200 μL of FC-40 alone was added from the inlet 221 of the second member 120 (state B).

### Experimental Example 2B

Experimental example 2B was produced as with experimental example 1B except that the well forming surface 11a of the first plate 11 and the well forming surface 12a of the second plate 12 were bonded by being pressed against each other for ten seconds.

### Experimental Example 3B

Experimental example 3B was made as with experimental example 1 except that the well forming surface 11a of the first plate 11 and the well forming surface 12a of the second plate 12 were bonded by being pressed against each other for three minutes.

### Evaluation

The first plate 11 and the second plate 12 in state A and the second plate 12 in state B were observed with a microscope. The devices used were as follows.

Microscope: BZ-800 (manufactured by KEYENCE CORPORATION); and

Objective lens: CFI Plan Apochromat Lambda 10X (manufactured by NIKON CORPORATION).

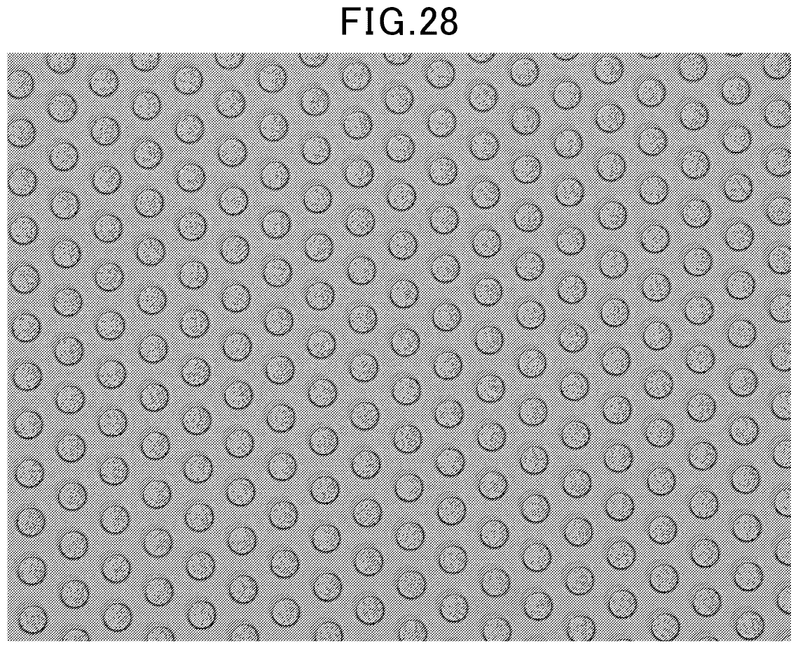

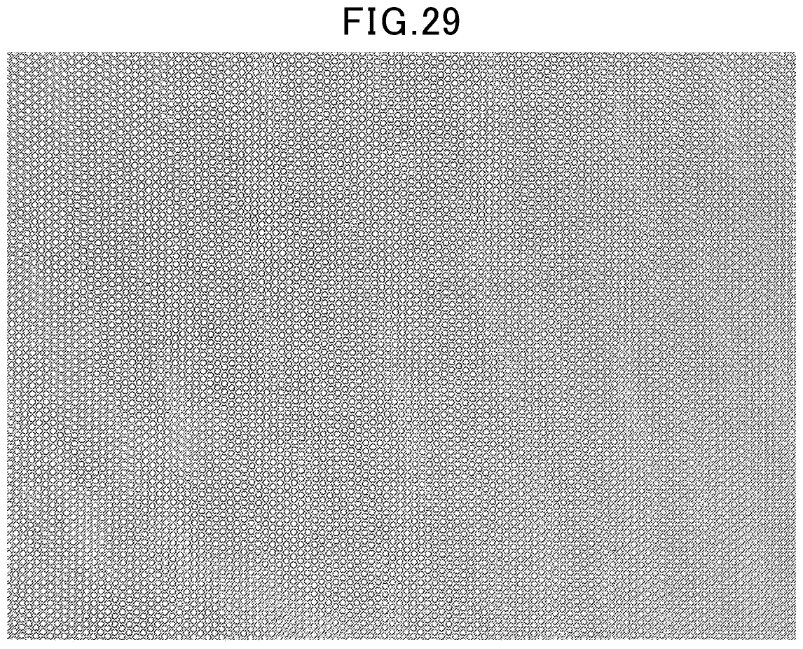

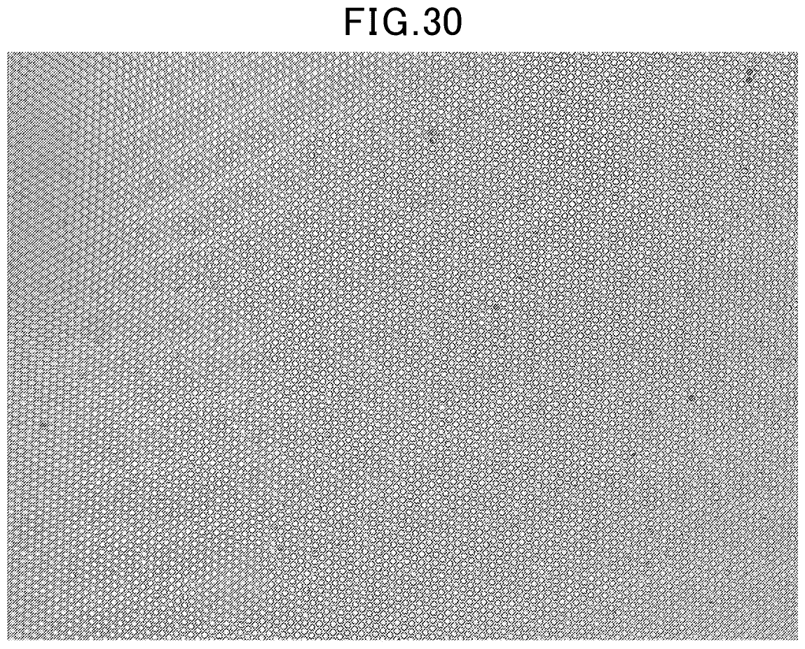

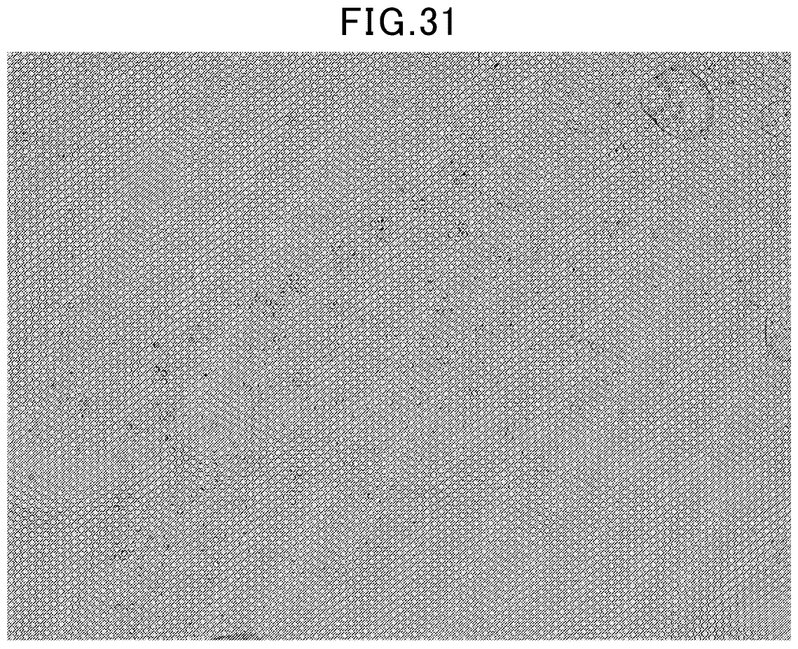

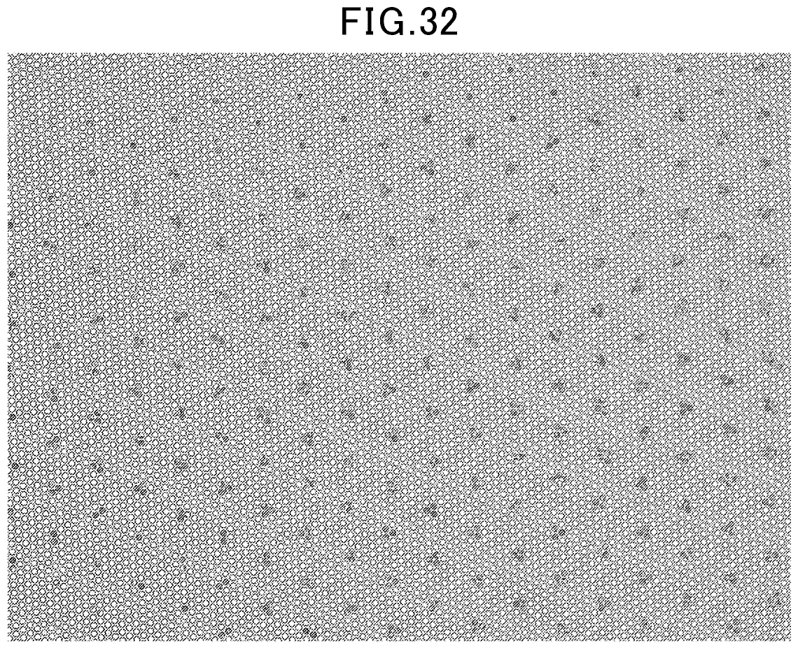

Each of FIGS. 28 to 32 is an enlarged photograph illustrating a result of an Example. FIG. 28 is an enlarged photograph of the first plate 11 in the state A, FIG. 29 is an enlarged photograph of the second plate 12 in the state A, and FIGS. 30 to 32 are enlarged photographs of the second plate 12 in the state B (FIG. 30: experimental example 1B, FIG. 31: experimental example 2B, and FIG. 32: experimental example 3B).

As results of experiments, the migration of capture particles was not substantially confirmed inexperimental example 1B in which the well forming surface 11a of the first plate 11 and the well forming surface 12a of the second plate 12 were kept in contact for six seconds. In contrast, the migration of capture particles was confirmed in the experimental example 2B of 10-second contact. The migration of capture particles was confirmed in the experimental example 3B of 3-minute contact in a mottled manner corresponding to the disposition of the first wells.

Density ρ of each of the capture particles used was 1.1 g/cm³ and a particle radius r of each of the capture particles was 1.5 μm (1.5×10⁻⁴ cm). When the density ρs of pure water was 1 g/cm³ and the viscosity η was 1 mPa·s (0.01 g/(cm·s)), and the gravitational acceleration was 9.8×10² cm/s², the falling speed of the capture particles was calculated as 0.49μm/s on the basis of the following Equation (2).

$$v = [ 2 g \cdot {r}^{2} \cdot \vert ρ - ρ s \vert ] / 9 η \qquad ( 2 )$$

(g represents gravitational acceleration (unit: cm/s²), r represents the radius (unit: cm) of the capture particle, ρ represents the density (unit: g/cm³) of the capture particle, ρs represents the density (unit: g/cm³) of the sample solution, and η represents the viscosity (unit: g/(cm·s)) of the sample solution.

When the shortest distance for a capture particle to completely migrate to a second well from a first well was the diameter of the capture particle, which was 3 μm, the shortest falling time was calculated as 6.1 seconds (=3/0.49). On the basis of an embodiment of the present invention, this calculation result supports a result that the migration of capture particles was not substantially confirmed in the experimental example 1B.

The results above confirmed that an embodiment of the present invention was effective.

Quantitative detection of target molecules in biological samples is used for early detection of diseases and prediction of medication efficacy. For example, in a case where the target molecules are protein, the protein is quantified by an enzyme-linked immunosorbent assay (ELISA) or the like. In addition, in a case where the target molecules are nucleic acids, the nucleic acids are quantified by real-time PCR or other methods.

In recent years, there has been an increasing need to detect target molecules as described above more accurately for the purpose of earlier detection of disease and the like. For example, JP 5551798 B, JP 2014-503831 A, and Kim S. H., et al., Large-scale femtoliter droplet array for digital counting of single biomolecules., Lab on a Chip, 12 (23), 4986-4991, 2012 each describe technology of producing enzyme reactions in a large number of micro compartments for monomolecular detection as a technique of accurately detecting target molecules. These techniques are referred to as digital measurement.

In digital measurement, a reaction container (also referred to as a detection device) including an extremely large number of micro compartments is filled with a sample solution and the sample solution is divided into the respective micro compartments. Signals from the respective micro compartments are then binarized, it is determined only whether target molecules included in the sample solution are present in the micro compartments, and the number of target molecules is measured. The digital measurement allows detection sensitivity and quantifiability to be significantly increased in comparison with conventional ELISA, real-time PCR, or other methods.

The digital measurement technology distributes target molecules included in a solution sample to micro compartments one by one and measures the number of micro compartments to which target molecules have been distributed. However, while there is an increasing need to detect target molecules more accurately as described above, there is a request to trace back to the sources (also referred to as target substances) of the target molecules, and detect and quantify the amount of target molecules released from the target substances. For example, conventional digital measurement technology allows cells (i.e., target substances) included in a solution sample to be detected with high accuracy, but it is difficult to further detect and quantify cytokines (i.e., target molecules) secreted from each of the cells with high accuracy.

A detection kit according to an embodiment of the present invention makes it possible to detect target molecules released from target substances in a solution, with high sensitivity. Another embodiment of the present invention is a target molecule detection method in which such a detection kit is used.

If it is possible in the method to redistribute the target molecules present in the micro compartments to other micro compartments, it is possible to analyze the target molecules released from the target substances or the target molecules included in the target substances in detail. It is, however, difficult to migrate substances present in micro compartments to other micro compartments and improvement has been required.

A detection kit according to an embodiment of the present invention includes: a detection device for a target molecule; and sealing liquid that is used for the detection device. The sealing liquid is a mixed solution of lipophilic liquid and a surfactant. The surfactant in the sealing liquid has a concentration of 1 vol % or more and 100 vol % or less relative to a saturation concentration of the surfactant in the sealing liquid. The detection device includes a first well plate including first wells on one surface, and a second well plate including second wells on one surface. The first well plate and the second well plate are disposed with the first wells and the second wells opposed to each other. A flow channel in which a fluid flows is formed between the first well plate and the second well plate. The first wells overlap with the second wells in plan view.

A target molecule detection method may use the detection kit. The target molecule detection method includes: filling each of the first wells with a sample solution including a target substance and isolating and sealing the sample solution in the first well using the sealing liquid; causing the target substance to release the target molecule in a first well of the first wells in which the one target substance is disposed; filling each of the second wells with a buffer, pressing a surface of the second well plate on which the second wells are formed against a surface of the first well plate on which the first wells are formed to bring the surface of the second well plate into contact with the surface of the first well plate, and distributing the target molecules to the respective second wells one by one from the first wells, the second wells are isolated from each other; and producing a reaction between the target molecule and a detection reagent to detect the target molecule.

A detection kit according to another embodiment of the present invention includes: a detection device of a target molecule; and sealing liquid that is used for the detection device, the sealing liquid being a mixed solution of lipophilic liquid and a surfactant, the surfactant in the sealing liquid having a concentration of 1 vol % or more and 100 vol % or less relative to a saturation concentration of the surfactant in the sealing liquid, the detection device including a substrate, a wall member that is provided on the substrate, and a cover member that is opposed to the substrate and in contact with the wall member, the cover member having an inlet and a discharge opening extending through the cover member in a thickness direction, a flow channel in which a fluid flows being formed between a top of the wall member and the cover member, the detection device including first wells surrounded by the substrate and the wall member.

A target molecule detection method may use the detection kit. The target molecule detection method includes: adjusting, by using a target substance and the sealing liquid, a W/O type emulsion obtained by dispersing droplets including the target substance in the lipophilic liquid; isolating and sealing a buffer in each of the first wells by liquid including lipophilic liquid; causing the emulsion to flow to the flow channel and replacing the liquid with the emulsion; causing the target substance in the droplets to release the target molecule; pressurizing the emulsion through the cover member and distributing the droplets to each of the first wells from the emulsion, the first wells are isolated from each other; and producing a reaction between the target molecule and a detection reagent to detect the target molecule.

In the detection kit, the detection device may include respective second wells that are provided on bottoms of the first wells as an upper surface of the substrate.

A target molecule detection method may use the detection kit. The target molecule detection method includes: isolating and sealing a buffer in each of the second wells using the sealing liquid; filling each of the first wells with a sample solution including a target substance and isolating and sealing the sample solution in the first well; causing the target substance to release the target molecule in a first well of the first wells in which the one target substance is disposed; pressurizing the sample solution through the cover member and distributing the target molecules to the respective second wells one by one from the first wells, the second wells are isolated from each other; and producing a reaction between the target molecule and a detection reagent to detect the target molecule.

In the detection kit, the surfactant may have a concentration of 10 vol % or more and 90 vol % or less.

A target molecule detection method according to yet another aspect of the present invention uses a detection device including a first well plate including first wells on one surface and a second well plate including second wells on one surface. The first well plate and the second well plate are used with the first wells and the second wells opposed to each other. The target molecule detection method includes: filling each of the first wells with a sample solution including a target substance and isolating and sealing the sample solution in the first well by sealing liquid; obtaining a particulate evaluation target including the target molecule from the target substance in a first well in which the one target substance is disposed; filling each of the second wells with a buffer, bringing a surface of the first well plate on which the first wells are formed and a surface of the second well plate on which the second wells are formed into contact, and distributing the evaluation targets to the respective second wells one by one from the first wells, the second wells being isolated from each other; and producing a reaction between the evaluation target and a detection reagent to detect the target molecule included in the evaluation target. The surface on which the first wells are formed and the surface on which the second wells are formed are in contact for a time longer than a contact time expressed by the following Equation (1) in the distributing. T=d1/v . . . (1) (T (unit: sec) represents the contact time, d1 (unit: μm) represents a diameter of the evaluation target, and v (unit: μm/sec) represents a migration speed at which the evaluation target migrates from the first well to the second well in the sample solution).

In the target molecule detection method, the surface on which the first wells are formed and the surface on which the second wells are formed may be in contact for a time longer than a contact time expressed by the following Equation (1)-1 in the distributing. T=d2/v . . . (1)-1 (d2 (unit: μm) represents a distance from bottom surfaces of the first wells to the surface on which the second wells are formed when the surface on which the first wells are formed and the surface on which the second wells are formed are brought into contact).

In the target molecule detection method, a reaction may be produced between the target molecule released from the target substance and a capture particle having a part to which the target molecule is specifically bound to obtain the evaluation target in the obtaining the evaluation target.

In the target molecule detection method, the distributing is performed with the detection device left at rest. The migration speed is speed expressed by the following Equation (2). v=[2g·r²·|ρ−ρs|]/9η . . . (2) (g represents gravitational acceleration (unit: cm/s²), r represents a radius (unit: cm) of the evaluation target, ρ represents density (unit: g/cm³) of the evaluation target, ρs represents density (unit: g/cm³) of the sample solution, and η represents viscosity (unit: g/(cm·s)) of the sample solution).

In the target molecule detection method, the capture particle may include a magnetic material, in which the distributing process is performed by applying magnetic force to the capture particle from outside of the detection device.

In the target molecule detection method, the distributing is performed by applying centrifugal force to the detection device.

According to an embodiment of the present invention, it is possible to provide a detection kit that makes it possible to detect target molecules released from target substances in a solution with high sensitivity. In addition, it is possible to provide a target molecule detection method in which such a detection kit is used.

Obviously, numerous modifications and variations of the present invention are possible in light of the above teachings. It is therefore to be understood that within the scope of the appended claims, the invention may be practiced otherwise than as specifically described herein.

1. A detection kit, comprising:
a detection device for a target molecule; and
a sealing liquid for the detection device,
wherein the sealing liquid is a mixed solution comprising a lipophilic liquid and a surfactant such that the surfactant has a concentration in a range of 1 vol % to 100 vol % relative to a saturation concentration of the surfactant in the sealing liquid, and the detection device includes a first well plate including a plurality of first wells on one surface, and a second well plate including a plurality of second wells on one surface such that the first well plate and the second well plate are configured to position the first wells and the second wells opposed to and overlapping with each other and form a flow channel between the first well plate and the second well plate.

2. A detection kit, comprising:
a detection device for a target molecule; and
a sealing liquid that is used for the detection device,
wherein the sealing liquid is a mixed solution of a lipophilic liquid and a surfactant such that the surfactant has a concentration in a range of 1 vol % to 100 vol % relative to a saturation concentration of the surfactant in the sealing liquid, and the detection device includes a substrate, a wall member configured to be positioned on the substrate, and a cover member configured to be positioned on the wall member such that the cover member is opposed to the substrate and in contact with the wall member and has an inlet and an outlet extending through the cover member in a thickness direction thereof, the cover member is configured to form a flow channel extending between a top of the wall member and the cover member, and the detection device has a plurality of first wells surrounded by the substrate and the wall member.

3. The detection kit according to claim 2, wherein the substrate of the detection device has a plurality of second wells formed in an upper surface of the substrate such that the upper surface of the substrate corresponds to bottoms of the first wells.

4. The detection kit according to claim 1, wherein the surfactant has a concentration in a range of 10 vol % to 90 vol %.

5. The detection kit according to claim 2, wherein the surfactant has a concentration in a range of 10 vol % to 90 vol %.

6. The detection kit according to claim 3, wherein the surfactant has a concentration in a range of 10 vol % to 90 vol %.

7. A target molecule detection method, comprising:
filling each of the first wells of the detection device in the detection kit of claim 1 with a sample solution including a target substance;
sealing the sample solution in the first wells using the sealing liquid such that the sample solution is isolated in the first wells;
causing the target substance to release the target molecule in a first well of the first wells in which the one target substance is disposed;
filling each of the second wells with a buffer;
pressing a surface of the second well plate on which the second wells are formed against a surface of the first well plate on which the first wells are formed such that the surface of the second well plate is brought into contact with the surface of the first well plate;
distributing the target molecules to the second wells isolated from each other one by one from the first wells; and
producing a reaction between the target molecule and a detection reagent such that the target molecule is detected.

8. A target molecule detection method, comprising:
adjusting, by using a target substance and the sealing liquid of the detection kit of claim 2, a W/O type emulsion obtained by dispersing a droplet including the target substance in the lipophilic liquid;
sealing a buffer in each of the first wells by a liquid including lipophilic liquid such that the buffer is isolated in each of the first wells;
causing the emulsion to flow to the flow channel such that the liquid is replaced with the emulsion;
causing the target substance in the droplet to release the target molecule;
pressurizing the emulsion through the cover member such that the droplet is distributed to each of the first wells from the emulsion and the first wells are isolated from each other; and
producing a reaction between the target molecule and a detection reagent such that the target molecule is detected.

9. A target molecule detection method, comprising:
sealing a buffer in each of the second wells of the detection device in the detection kit of claim 3 using the sealing liquid such that the buffer is isolated in each of the second wells;
filling each of the first wells with a sample solution including a target substance such that the sample solution is isolated and sealed in the first well;
causing the target substance to release the target molecule in a first well of the first wells in which the one target substance is disposed;
pressurizing the sample solution through the cover member such that the target molecules are distributed to the second wells one by one from the first wells and the second wells are isolated from each other; and
producing a reaction between the target molecule and a detection reagent such that the target molecule is detected.

10. A target molecule detection method, comprising:
providing a detection device comprising a first well plate including a plurality of first wells on one surface and a second well plate including a plurality of second wells on one surface such that the first wells and the second wells are opposed to each other;
filling each of the first wells with a sample solution including a target substance such that the sample solution is isolated and sealed in the first well by sealing liquid;
obtaining a particulate evaluation target including the target molecule from the target substance in a first well in which the one target substance is disposed;
filling each of the second wells with a buffer;
bringing a surface of the first well plate on which the first wells are formed and a surface of the second well plate on which the second wells are formed into contact;
distributing the evaluation targets to the second wells isolated from each other one by one from the first wells; and
producing a reaction between the evaluation target and a detection reagent such that the target molecule in the evaluation target is detected,
wherein the surface on which the first wells are formed and the surface on which the second wells are formed are in contact for a time longer than a contact time expressed by T=d1/v in the distributing where T is a contact time in sec, d1 is a diameter of the evaluation target in μm, and v is migration speed in μm/sec at which the evaluation target migrates from the first well to the second well in the sample solution.

11. The target molecule detection method according to claim 10, wherein the surface on which the first wells are formed and the surface on which the second wells are formed are in contact for a time longer than a contact time expressed by T=d2/v in the distributing where d2 is distance in μm from bottom surfaces of the first wells to the surface on which the second wells are formed when the surface on which the first wells are formed and the surface on which the second wells are formed are brought into contact.

12. The target molecule detection method according to claim 10, wherein a reaction is produced between the target molecule released from the target substance and a capture particle having a part to which the target molecule is specifically bound to obtain the evaluation target in the obtaining of the evaluation target.

13. The target molecule detection method according to claim 11, wherein a reaction is produced between the target molecule released from the target substance and a capture particle having a part to which the target molecule is specifically bound to obtain the evaluation target in the obtaining of the evaluation target.

14. The target molecule detection method according to claim 8, wherein the distributing is performed with the detection device left at rest, and the migration speed is speed expressed by v=[2g·r²·|ρ−ρs|]/9η where g is gravitational acceleration in cm/s², r is a radius in cm of the evaluation target, ρ is density in g/cm³ of the evaluation target, ρs is density in g/cm³) of the sample solution, and η is viscosity in g/cm·s of the sample solution.

15. The target molecule detection method according to claim 12, wherein the capture particle includes a magnetic material, and the distributing is performed by applying magnetic force to the capture particle from outside of the detection device.

16. The target molecule detection method according to claim 10, wherein the distributing is performed by applying centrifugal force to the detection device.
